(19) United States
(12) Patent Application Publication
(10) Pub. No.: US 2021/0221369 A1
(43) Pub. Date: Jul. 22, 2021

(54) VEHICLE DISTANCE WARNING AND SIGNALLING SYSTEM WITH DYNAMICALLY GENERATED TTC (DWSS-TTC)

(71) Applicant: Hamid Reza Kashefy, Gatineau (CA)

(72) Inventor: Hamid Reza Kashefy, Gatineau (CA)

(21) Appl. No.: 17/079,233

(22) Filed: Oct. 23, 2020

(30) Foreign Application Priority Data
Oct. 24, 2019 (CA) 3059951

(51) Int. Cl. B60W 30/16; B60W 30/095; B60W 30/09; B60W 40/105; B60W 50/14; B60W 10/20; B60W 10/18; G01S 13/931; B60Q 1/52; B60Q 1/44; F21S 10/06; G06F 17/11

(52) U.S. Cl. CPC B60W 30/16; B60Q 2400/20; B60W 30/09; B60W 40/105; B60W 50/14; B60W 10/20; B60W 10/18; G01S 13/931; B60Q 1/525; B60Q 1/444; F21S 10/06; G06F 17/11; B60W 2050/143; B60W 2050/146; B60W 2554/4042; B60W 2554/802; B60W 2554/804; G01S 2013/9325; G01S 2013/93271; G01S 2013/93272; B60W 30/0956

(57) ABSTRACT

A system and a method are provided for calculating variable forward and backward unsafe distances between two tailgating vehicles for generating variable forward and backward staged Time-to-Collision pulses in real-time driving. The system also generates low-speed pulses and uses its speed sampling method for producing forward and backward distance reduction rate pulses.

The system uses the staged backward Time-to-Collision pulses and the backward distance reduction rate pulses for producing distance warning signals on the rear of its host vehicle. The system also uses its low-speed pulses for implementing a stoplight on the rear of vehicles regardless of vehicles' distance. The system provides the staged forward Time-to-Collision pulses and the forward distance reduction rate pulses for supporting Autonomous Emergency Braking (AEB) system of its host vehicle with braking and steering initiation and intensity.

### BACKGROUND

### 1. Technical Field

A system or method for determining forward and backward unsafe distances between a vehicle that hosts the system and its lead and tailgating vehicles. The system also produces unsafe forward and backward distance warning pulses and signal for assisting Autonomous Emergency Brake (AEB) of the host vehicle and for warning drivers the tailgating vehicles. The system comprises an unsafe backward distance warning and backward distance reduction rate warning 600 that is described by a method 500 and is coupled with backward distance and speed sensors of its host vehicle. The system may also comprise an unsafe forward distance warning and forward distance reduction rate warning 800 that is described by a method 700 and is coupled with forward distance and speed sensors of its host vehicle.

Both of the systems 600 and 800 comprise an unsafe distance warning pulse generator 200 described by a method 100 and a distance reduction rate pulse generator 400 described by a method 300. The systems 200 and 400 implement the core functionalities of the system based on the type of distance and speed sensors that are coupled with them.

### 2. Background Information

The basic necessity for implementing an effective forward and backward collision warning systems is the ability to dynamically monitor headway variations between two following or tailgating vehicles for providing more time for following drivers to react to potentially hazardous situation on the roads. This can be achieved by reducing perception-reaction time (prT) of following-drivers and by providing longer time and distance as headway for following drivers to perceive and react to a stimulus in diving. A truly useful collision avoidance system can greatly alleviate the problem of long PRTs and short headways by providing: 1—change of color of lights on the rear of vehicles; 2—advanced and meaningful unsafe distance warning signals; and 3—distance reduction rate warning signals; based on previous and credible traffic safety researches. Moreover, a collision warning system which can also assist the Autonomous Emergency Braking systems (AEB) to improve their functionality is of high value.

In the drawings, which form an introductory part of this specification,

FIG. 1-a illustrates analysis of safe distance between two vehicles in emergency braking;

FIG. 1-b illustrates Maximum deceleration rates, and

FIG. 2 and FIG. 3 illustrate the functions of the system in driving.

More drawings will be presented later in this disclosure to reveal the methods and systems used to implement the functions of the system.

Also, in this disclosure, the following terms mean as they are defined here or as they are defined within the disclosure:

Driver means a person or a computer that controls a vehicle;

LV means a lead-vehicle or driver of the lead vehicle LV, FV means a vehicle that follows its lead-vehicle or the driver of the following vehicle FV; and

Y means a vehicle that may lead its following-vehicle (FV) and may follow its lead-vehicle (LV) and therefore, the Y can be either a lead-vehicle or a following-vehicle or both depending on the context of the paragraph which discusses the driving situation.

2.1. Safer Headway Between Vehicles:

It is necessary to define a safer distance between two tailgating vehicles in order to create a solution that can encourage and help drivers to increase their headway in actual driving. Referring to the car following scenario shown in the introductory FIG. 1-a, the vehicle (FV) follows its lead-vehicle (Y) with an equal constant speed at an initial relative distance of relDᵢ meters. At time t1, the Y brakes in an emergency in order to stop. The FV continues to travel with the same speed during a perception and reaction distance (prD) until it brakes at time t2=t1+prT where the prT is the perception-reaction time of driver of the FV to the braking by the Y. By the time the FV brakes, the Y has traveled the braking distance (bdY). At time t3, the Y stops after traveling a total braking distance of (tbdY). The FV comes to stop at time t4 after traveling a total braking distance of (tbdF), also with hard braking. Consequently, if (relDᵢ+bdY)−prD>0 then by the time that the two vehicles come to full stop, they have about one car length of distance from each other (given that the FV reduced speed equally).

Imagining that the performance of both the FV and the Y meet the requirements, it follows from the example that the FV and the Y must have an initial safer minimum distance (mD) as the relDᵢ where the mD=prD−bdY, to avoid an immediate collision in the situation that the Y brakes to decelerate at a very high rate. It is factual that in this scenario when the Y brakes, the relative speed of the two vehicles increases while the distance between them decreases. Separately, if the speed of the two vehicles increases, stopping distance of the FV increases as the prT of the following-driver increases at higher speeds as per previous traffic safety researches. Therefore, an effective advanced driver assistance systems (ADAS) system of the Y must produce warning signals at a safer initial distance mD that is preferably far greater than the relDᵢ before the Y brakes and before the brake lights of the Y turn on.

2.2. Rear-End Crashes:

Despite all the added safety features on motor vehicles, as an object on the road, a vehicle (including autonomous vehicles) always has the potential to be rear-ended. The standard red brake lights with only on and off signals cannot provide adequate informative warning signals for drivers in car-following situations in regards to distance and speed variations of lead-vehicles, thus the standard brake lights allow many preventable accidents to happen. High rate of traffic accident fatalities and economic damages continue because of no improvements to the brake lights and because of inadequate functionality of the Autonomous Emergency Braking systems (AEB) which does not calculate dynamically the Time-to-Collision (TTC) during driving.

Different AEB systems support braking at different speeds and pre-set, but do not dynamically calculate, estimated values for TTC which is usually a fraction of a second. In fact, “TTC is the time at which a collision is deemed as being inevitable when neither steering nor braking intervention would avoid the impact . . . . The estimate of the TTC is typically derived from physical testing with the subject vehicle on such a dry surface. This data is then stored within control system.” [1].

Although AEB has improved vehicle's safety to some extent, the lack of full capability of AEB to prevent crashes results from its inadequate and pre-set Time-to-Collision (TTC). Instead of calculating the TTC dynamically based on speed and distance of tailgating vehicles, AEB has a pre-set and short estimate of the TTC in its memory to compare it with a time (T) that AEB dynamically calculates by dividing relative distance with relative speed relating to a host following-vehicle (Y) that follows its lead-vehicle (LV). When the relative speed between two tailgating vehicles is zero, the AEB's calculation of the time T may lead to divide by zero which either limits the functionalities of the AEB or can result in unexpectable consequences. Also, because AEB performs its calculations by using a software in driving, it may suffer from computational latency for activating automatic braking when the pre-set and fixed TTC of AEB reaches its dynamically calculated time T. There have also been numerous indications that AEB system on some vehicles behaved erratically which maybe related to AEB's formula and its computation by using a software.

Traffic safety and human behavior reasearchers have determined that, “A (rear-signaling) system to signal hard lead-vehicle decelerations (peak braking above 0.55 g) could potentially address 56 percent (109 out of 194) of near-crash events.” [2]. Furthermore, a literature review and analysis conducted by the NHTSA revealed that “experts voted “MUST” in consensus for implementation of a rear light and signalling device that prevents rear-end collisions by addressing at least one of the contributing factors.” [3].

Additionally, other international studies such as one by the Federal Highway Research Institute of Germany concluded that emergency braking situations require an alternative to existing brake lights and suggests the use of flashing lights (in select emergency situations) to quickly gain the attention of drivers in order to prevent rear-end crashes [4]. Such studies demonstrate the need for immediate implementation of a novel and advanced distance warning and signalling system such as DWSS based on the studies.

Studies on traffic safety and human behavior also states that “The research on drivers' headway judgements shows that we are incapable of this task too, and we need some kind of an aid . . . . We do not make that assumption with respect to speed and that is why we have speedometers in our cars.” [5]. Researchers believe that “Arguably, most of the crashes involve insufficient headway.”[6].

Although the prior art addresses the issue of safe distance and warnings for tailgating (or following) vehicles, these methods are inadequate and they cannot implement a viable mean to implement the core necessities for preventing traffic crashes. Also, such systems cannot and do not offer improvements to the functionality of the autonomous emergency braking (AEB) systems. Examples of such prior arts are Canadian patent 02194982 and U.S. Pat. No. 10,699,138.

### SUMMARY

System or method which uses electronics only without using a software in order to implement the logic of a novel formula (1) for determining forward and backward unsafe distances between two tailgating vehicles and for producing unsafe distance warning pulses and signals. The system may also comprise a modified version of reference speed method of Dynamic Traffic Light Vehicle Signalling Display bearing patent number CA02238542 for detecting distance reduction between the two vehicles in order to produce forward and backward distance reduction warning pulses and signals.

The system uses hardware-only with computational latency of almost 0 s for calculating stages of ‘unsafe distance’ between two following vehicles in real-time. The system uses the calculated unsafe distances in order to generate ‘unsafe distance’ pulses that represent stages of Time-to-Collision (STTC) between the two vehicles in real-time. The system also realizes decrease in distance between the two vehicles and generates ‘distance reduction’ (dR) pulses. The system is designed with respect to previous research findings in order to significantly improve rear signalling of vehicles while it can also improve AEB systems and thus can assist autonomous vehicles.

The traditional brake signal on the rear of vehicles only and inadequately informs a following-vehicle that its lead-vehicle is braking. Vehicle manufacturers pre-set a TTC value in the memory of their AEB system for comparing the pre-set TTC with a time (T) which the AEB's software calculates as T=relative distance/relative speed. When driver of a following-vehicle does not react on time to short distance of its lead-vehicle, the AEB of the following-vehicle may realize that its pre-set TTC is reached and may brake autonomously. While AEB does not calculate the TTC in real-time, AEB suffers from an improper method for calculating the time T that may also lead to unexpected behaviours of the AEB.

AEB needs a short pre-set TTC for preventing itself from annoying and/or dangerous early braking while the short TTC may not be enough to prevent crashes in many critical situations. The DWSS-TTC system can provide its generated STTC and dR warning pulses for the AEB of a host vehicle (Y), so that the AEB: i) prepares the brakes of the Y in advance when Y reaches the first STTC stage of its lead-vehicle (LV); and ii) uses the dR pulses to apply incremental pressure on the brakes while subsequent STTC stages are reached and driver of the Y does not react to its distance reductions from the LV.

Unlike the simple brake lights, the calculated warning signals of the system of a host vehicle (Y) help driver of a vehicle (FV) that follows the Y to maintain a safe headway from the Y. This prevents the FV from reaching a critical TTC thus preventing or reducing the need for panic braking by the driver or by the AEB of the FV. The system also flashes lights by the calculated dR pulses to communicate the distance reduction rate of the Y to the FV.

### BRIEF DESCRIPTION OF THE DRAWINGS

Many features and inventive features of the system are illustrated in the numerous drawings which form a part of this specification. In accordance with the requirements of the patent laws, systems and methods (collectively the “system”) are explained and illustrated in preferred embodiments. However, it must be noted that inventive systems may be used in ways other than is explicitly explained and illustrated in this disclosure without leaving from its spirit or scope.

In the additional drawings, which form a part of this specification,

FIG. 1-a, FIG. 2 and FIG. 3 illustrate primary analysis of unsafe distance and stages of TTC;

FIG. 1-b illustrates maximum deceleration rates of vehicles with emergency braking at different speeds.

FIG. 4 and FIG. 5 illustrate graphs that describe long TTC resulted from system's calculations of unsafe distance (wD);

FIG. 6 is a flowchart diagram illustrating method 100 for generating unsafe distance warning pulses and low speeds pulses;

FIG. 7 Illustrates a brief outline of exemplary components of sections S1 to S7 of the system for implementing the safe zone, unsafe distances and low-speed pulse generator system 200;

FIG. 8 is a flowchart diagram illustrating an example of method 300 for generating distance reduction (dR) pulses;

FIG. 9 is a configuration diagram illustrating an exemplary hardware implementation of the distance reduction warning pulse generator 400;

FIG. 10 is a flowchart diagram illustrating method 500 for implementing an exemplary backward collision warning system;

FIG. 11 is a block diagram illustrating an exemplary backward Collison warning system 600 described by the method 500;

FIG. 12-a illustrates an exemplary arrangement of lights of the system 500 and FIG. 12-b to FIG. 12-i elaborate the functions of the lights;

FIG. 13 is a flowchart diagram illustrating method 700 for implementing an exemplary forward collision warning system;

FIG. 14 is a block diagram illustrating an exemplary forward Collison warning system 800 described by the method 700;

FIG. 15 illustrates a block diagram of preferred embodiment of the system as system 900 which is comprised of both the forward collision warning system 600 and the backward collision warning system 800;

FIG. 16 is a configuration diagram illustrating an exemplary hardware implementation of the unsafe distance and low-speed pulse generator 200;

FIG. 17 and FIG. 18 illustrate an example of hardware configuration which uses the low-speed pulses R02 and R42 for activating and deactivating the ground connection to the lights of the system.

FIG. 19 illustrates an exemplary outline of sending and using unsafe forward distance warning pulses and dR pulses, and unsafe backward distance warning pulses and dR pulses of the system to the inside of the compartment of a host vehicle and to its coupled AEB system.

FIG. 20 illustrates an exemplary configuration diagram for transferring the generated backward STTC and dR pulses to electronic and electrical circuits of the system for producing backward warning signals of the system.

### DETAILED DESCRIPTION

This disclosure now makes detailed references to exemplary embodiments of the system and some examples of the embodiments are illustrated in the accompanying drawings.

1. Introduction

A system or method for calculating variable forward and backward unsafe distances between two tailgating vehicles for generating variable forward and backward staged Time-to-Collision (STTC) pulses in real-time driving. The system also conditionally produces forward and backward distance reduction rate pulses during the stages of its calculated forward and backward STTC. The system comprises an unsafe backward distance warning and backward distance reduction rate warning 600 that is described by a method 500 and is coupled with backward distance and speed sensors 610 and 620 of its host vehicle. The system may also comprise an unsafe forward distance warning and forward distance reduction rate warning 800 that is described by a method 700 and is coupled with forward distance and speed sensors 810 and 820 of its host vehicle.

The system uses its backward STTC pulses and its backward distance reduction rate pulses for producing distance warning signals by a rear-signalling display 650 on the rear of its host vehicle. The system provides its forward STTC pulses and its forward distance reduction rate pulses as input control reference pulses for Autonomous Emergency Braking (AEB) system of its host vehicle in order to support the AEB with braking and steering initiation and intensity.

Both of the systems 600 and 800 comprise an unsafe distance warning pulse generator 200 described by a method 100 and a distance reduction rate pulse generator 400 described by a method 300. The systems 200 and 400 implement the core functionalities of the system based on the type of distance and speed sensors that are coupled with them. The system 600 also comprises an in-vehicle warning device 620. The system 800 may also comprise an in-vehicle warning device 830.

The system uses the logic of a novel formula for dynamically calculating unsafe distance (wD) between two tailgating vehicles in real-time driving. The system calculates unsafe distance (wD) between two following or tailgating vehicles in order to define stages of Time-to-Collision (TTC) or (STTC) as stages of unsafe distance between the two vehicles. The system also uses a speed-sampling method for indicating rate of decrease of distance between the two vehicles within the calculated unsafe distance wD. Unsafe distance warning pulse generator (system 200 or method 100) and/or distance reduction warning pulse generator (system 400 or method 300) may be comprised in Advanced Driver Assistance Systems (ADAS) to create backward collision warning systems such as the system 600 or to create forward collision warning systems such as the system 800.

The novel formula substantially considers only speed of two following-vehicles as its only two variables; one that is speed (vY) of its host vehicle (Y) and the other is speed (vF) of a vehicle (FV) that follows the Y or speed (IV) of a vehicle (LV) that leads the Y.

|wD|=|vF−0.8vY| (1)

Where the calculated value of wD reveals an unsafe headway (i.e: physical or time distance) between the two vehicles FV and Y. The system will compare the wD with radar measured distance (radD) between the two vehicles for determining whether the radD between the two vehicles should be considered as unsafe distance in order indicate onset of a Time-to-Collision (TTC) between the two vehicles. So that the TTC is duration of time that is greater than the duration of time that the FV needs to travel the distance (prD) (with its current speed or the speed of the FV at the moment that the wD is calculated) during the established perception-reaction time (prT) of drivers.

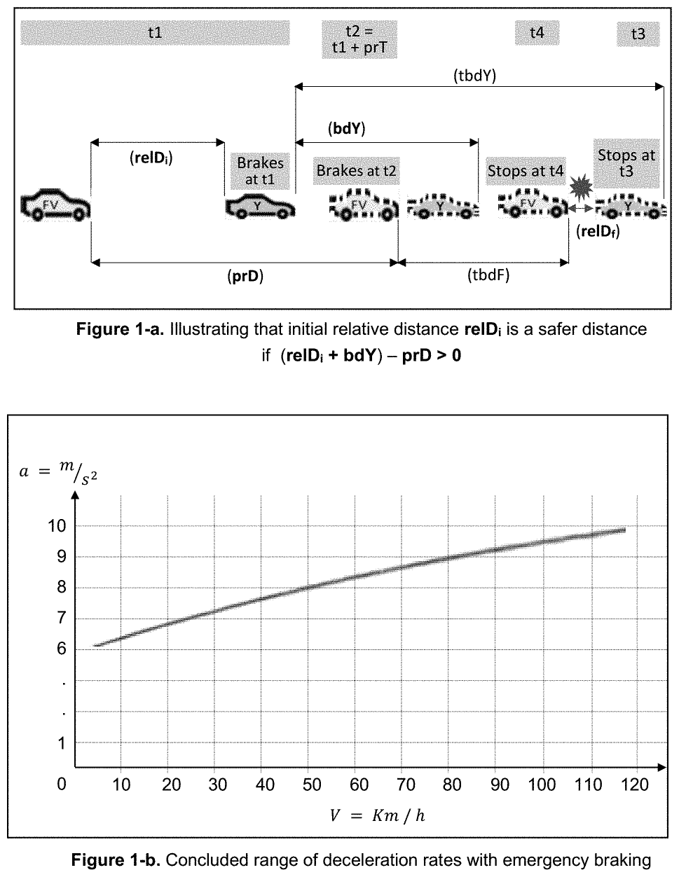

Notably, the novel formula uses only the speeds of the two tailgating vehicles to derive the magnitude of the unsafe distance wD. If the host vehicle Y follows another vehicle (LV) that leads the Y then in the formula (1), the vY is replaced by speed (vL) of the vehicle LV and the vF is replaced by speed vY of the host vehicle Y which follows the LV. So that the formula (1) can be used to calculate a potentially unsafe backward distance wD between the vehicle Y and its following vehicle FV, and to calculate a potentially unsafe forward distance wD between the Y and its lead vehicle LV. Thus the novel formula can be used for determining variable TTCs in real-time driving only by using speed of the host vehicle Y and, speed of the vehicle FV that follows the Y or speed of the vehicle LV that leads the Y. So that the TTC that is determined by the system is a time greater than the time that the FV takes to travel a distance (prD) during perception-reaction time (prT) of driver of the FV after emergency braking by the host vehicle Y is elaborated by the FIG. 1.

As introduction, the usefulness of the formula 1 will now be justified first, to show why a calculated value of wD that is determined by the system as an unsafe distance between two tailgating vehicles is an unsafe distance indeed. Traffic safety researches reveal that contributing factors to rear-end crashes are such as divers' inattention which increases the prT of following-drivers, stopped lead-vehicles, shorter headways between vehicles which results in reduced time for following-drivers to react to a stimulus lead-vehicle. According to a final report by the University of Michigan and Texas A&M University, the prT of drivers of ages 16 to 69 ranges from 1.1 s to 2.2 s. [7]. Another study by Virginia Transportation Research Council reported that the average perception-reaction time of drivers is around 1.5 s [8].

Also, a driving simulator study concludes that “the most efficient threshold values of TTC seem to be 2.5 and 3 s. These results should be considered for the development of Collision Avoidance Systems.” [6]. Considering the average prT of 1.5 s for drivers, the system uses electronics-only in order to implement the novel formula 1 for dynamically calculating, in real-time driving, a long and variable TTC with an average of 2.4 s to 3.3 s without using a software and with computational latency of almost 0 s.

Knowing the average of 1.5 s prT of drivers and maximum deceleration rates at different speeds are necessary for developing a solution for preventing traffic crashes as the deceleration rates of vehicles affect their stopping distance. FIG. 1-b which shows the maximum deceleration rates with emergency braking at different speeds was concluded from previous traffic research studies [2] and [9].

While referring to the FIG. 1 and considering the system as backward collision warning system 600 (DWSS-BCW) on the host vehicle Y, about 1.5 s after the Y brakes and before its following vehicle FV brakes, the distance between the FV and the host vehicle Y depends on the following (while it is hypothesised that the dynamic performance of both vehicles meets the standards): i) The initial distance relDᵢ between the FV and the Y; ii) The speed (vY) of the Y; iii) The speed (vF) of the FV; iv) The deceleration rate of the Y; and v) the deceleration rate of the FV.

As a result of the above considerations, the calculation of the TTC must involve the speed of each of the tailgating vehicles (the FV and the Y) rather than solely their relative speed. Also, because the distance between the FV and the Y is directly proportional to the speed of the FV and the Y, the following equation (2) has the potential to produce a value as the warning distance (wD) that is proportional to the desired longer TTC with stages or (STTC). Thus the wD can also be referred to as the STTC. Where the coefficient n of the vY must be less than coefficient m of the vF because during the prT of the FV only the Y is braking, where:

|wD|=|m*vF−n*vY| where m and n>=1 and m>n (2)

Rather than considering relative speed as the main factor to determine the long TTC, the system considers vehicles' speeds. In developing this formula, it was evident that the value of the parameter m must be equal to 1. However, the value of the parameter n was not apparent and needed to be determined through experimentation. Consequently, the inventor coded a software algorithm based on the equations 1, and the following equations 3, 4 and 5 to help deciding the optimal value for the parameter n:

$$\begin{matrix}\frac{( v {Y}_{1}^{2} - v {Y}_{2}^{2} )}{( 2 * a )} braking distance of the Y as per physics & ( 3 ) \\ mD = ( v {F}_{m / s} * prT ) - \frac{( v {Y}_{1}^{2} - v {Y}_{2}^{2} )}{( 2 * a )} & ( 4 ) \\ TTC = ( \frac{w D}{m D} per prT ) * prT & ( 5 )\end{matrix}$$

Where the average of prT of drivers is determined to be 1.5 s by traffic safety researches. The software received as input a large number of values as the speed (vY) of the lead-vehicle ranging from 5 km/h to 140 km/h with increments of 5 km/h, and relative speeds (vR) of 5 km/h to 40 km/h also with 5 km/h increments. High rates of deceleration from 6 to 10.2 m/s² with equal increments were used based on the information in FIG. 1-b. The software also used coefficient of friction (φ=1 and received as input best guesses for the parameter “n” of the novel formula 1 and prT of 1.5 s. Because p=0.8 is more realistic value for an average car with good tires on good dry roads, the calculations with ρ=1 result in the values of wD that correspond to even higher TTC since stopping distance of cars is increased as p is decreased. That is, although the calculated wD distance is a fixed value which does not increase by unfavourable road conditions such as wet road, the stopping distance of the host vehicle Y (and the FV) increase on wet roads and the driver of FV gets more time to control her/his vehicle after s/he perceives the warning signals at the onset of the wD that is calculated by the system of the host lead-vehicle Y.

Table 2 summarizes the lower and higher averages of the software calculated mD, wD and TTC for three ranges of speeds when the relative speed of the two vehicles ranges from 5 km/h to 40 km/h. The average of the lower bond and upper bond of the TTCs resulted from the formula 1 are (2.4 s to 3.3 s) and seem to be optimal and supported by the previous research [6].

TABLE 2
Software calculated range of the minimum distance mD, the warning distance wD
and its corresponding TTC while considering coefficient of friction of 1.

| | the vY | the vF | | | | |
|---|---|---|---|---|---|---|
| μ = 1 | km/h | km/h | −a_{m/s}² | mDₘ | wDₘ | wDs as TTC |
| Range 1 | 10 to 50 | 15 to 90 | 6.15 to 7.50 | 5.6 to 25.1 | 7 to 50 | 1.86 s to 2.99 s |
| Range 2 | 60-90 | 65 to 130 | 7.50 to 8.70 | 25.1 to 26.5 | 17 to 58 | 2.35 s to 3.29 s |
| Range 3 | 100-140 | 105 to 180 | 8.70 to 10.2 | 26. 5 to 28.1 | 25 to 68 | 3.07 s to 3.62 s |

As output, the software produced different values as the mD (by using the physics formulas), the wD (by using the novel formula 1 with the best guesses for the parameter n), and TTC proportional to the produced values of wD for analysis. Comparison of the software calculated values revealed that the simplest and most efficient formula for finding the most reasonable and effective value as the wD (that is always greater than prD−bdY of the FIG. 1-a) is when m=1 and n=0.8. Hence, the novel formula was finalized with n=0.8 as a preferred value. The higher threshold of the unsafe distance wD (compared to the mD) is required between the two vehicles to prevent the FV from reaching critical TTC immediately after the host vehicle Y decelerates quickly and before its following-vehicle the FV reacts accordingly with prT delay. This insight into determining a safer distance based on speed of vehicles only (but not necessarily relative speed of the vehicles), resulted in the conclusion that the robust novel formula 1 can serve a life saving purpose.

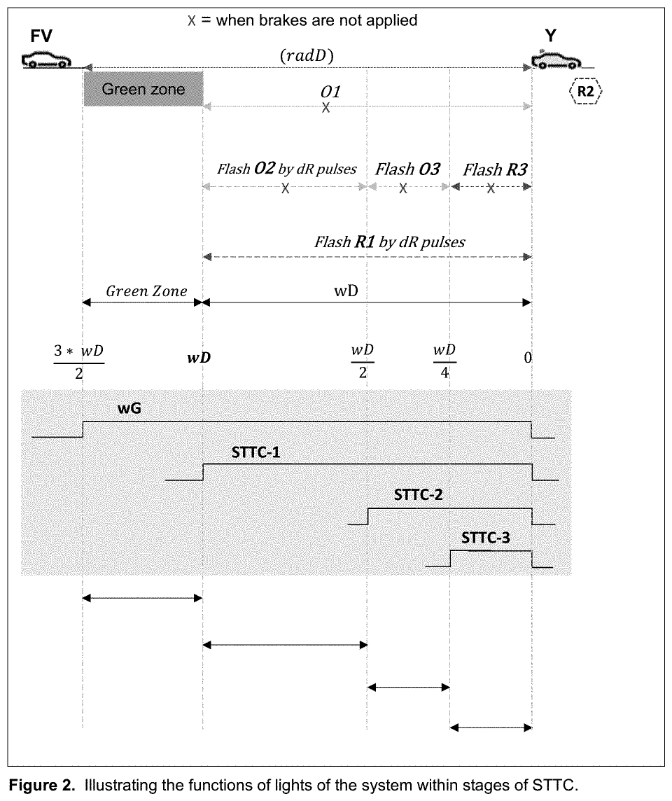

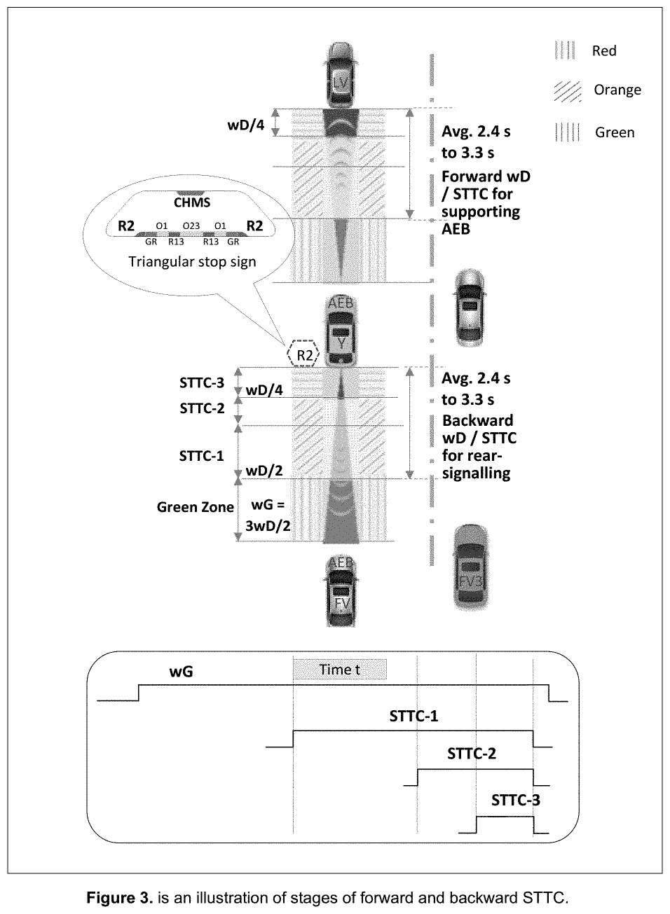

The graphs in FIG. 4 and FIG. 5 are plotted based on the results of the calculations of the formula 1 to the formula 5 in order to show further the usefulness of the calculated unsafe distance wD for providing a long and staged TTC as the STTC. Referring to the FIG. 4, a striking feature of the calculated wD by the novel formula is that not only is the magnitude of the wD increased by an increase in the assigned values of speeds to the variables vF and vY of the novel formula 1, but also the magnitude of the wD and its corresponding TTC is increased as the relative speed of the vehicles increases. This effect is shown in FIG. 4 by three pairs of graphs where the pairs show the wD (linear) and its corresponding TTC (curve) at low, medium and high relative speed ranges and low to high vY speed ranges.

Another conspicuous characteristic of the wD that is revealed in the graphs of the FIG. 4 is that between very low speeds of about 10 km/h to 35 km/h as vY and about 15 km/h to 70 km/h as vF (when considering relative speeds of 5 km/h to 45 km/h), the TTC is reduced and a turn point happens approximately between 10 km/h and 35 km/h of speed vY of the lead-vehicle. The TTC then regains its magnitude and continues to increase as speed and separately relative speed increase. Lower speeds are typically the characteristics of city driving where drivers' reaction times are usually shorter in higher traffic density [10]. The Lower values of the wD within the lower speed ranges result in less frequent warning signals by the system because the two trailing vehicles should get closer so that the system considers the wD as unsafe distance. With lower speeds, drivers can control their vehicles better and thus need shorter TTCs. As the warning lights signal less frequently (and activate only in emergency situations at much shorter distances), they become more acceptable by drivers.

Another noticeable and interesting fact that is revealed from the analysing of the TTC graph of the FIG. 4 is that, the calculated TTCs at very low speeds of under 10 km/h (and when lead-vehicle is stopped with zero speed), are very high which result in creating much earlier warnings for the FV to perceive and react to a stopped lead-vehicle on time. Research indicates that while the frequency and severity of accidents increase by speed [11][12], rear end collisions occurring at lower speeds (under 10 mph) represent a great percentage of car accidents [13]. This confirms the usefulness of the variations in the TTC graphs as shown in the FIG. 4.

FIG. 5 shows the comparison between the minimum distance mD (of the FIG. 1-a) as calculated by the equation 3 based on physics, the wD that is calculated by the novel equation 1 and the actual headway maintained by drivers in real driving as per previous research [5]. The actual headway values used to plot the graph are the average of headway as distance in different speed ranges from previous studies [5]. The comparison reveals that as speed and separately relative speed increases, the calculated wD creates a much safer headway (as physical and time distance) for drivers. So that when the wD is used to implement the distance warning and signalling system (DWSS), the system can help the drivers not to be in the red zone that will might be critical stage of the TTC when lead-vehicle brakes for emergency.

Although the system uses the logic of the mentioned above formula as the simplest and most effective equation for dynamically calculating the wD in car following situations, the calculation of the wD is not restricted to this particular equation which could have other variations to account for different vehicle types and situations. For example, replacing the m in the formula 2 with ⅚ would also provide a useful value as the wD. It is possible to increase or decrease the magnitude of the calculated wD. For example, the magnitude of the wD can be reduced by using a higher value for the coefficient n of the vY such as 0.9 or can be increased by using a lower value for n such as 0.7. If the coefficients m and n of the formula 2 are selected with such values that the calculated wD is too long relative to the speed and distance of the vehicles, then the warning lights and signals of the system will become activated unnecessarily at much longer ranges, resulting in the warning lights to be less effective as with the DTL. However, because the average truck braking distance is 60 percent longer than the automobile braking distance, the parameter n of the novel formula can be reduced to 0.7 for example, in order to recognize the wD as unsafe distance between a truck and its lead-vehicle earlier. So that when the system is installed as forward collision warning system (DWSS-FCW) on trucks, the system will provide truck drivers and the AEB of their truck with forward warning signals at threshold of a longer unsafe distance wD or TTC.

Without the formula 1, a complicated system would have to use software to perform calculations similar to the equations 3 to 5 in order to find prD, braking distance bdY and the minimum safe distance mD of the FIG. 1-a. Also, when software is involved, glitches can potentially happen and warning pulses may not be generated or there can be further computational delays.

2. Vehicle Mounted DWSS

The system uses electronics only for dynamically calculating the value of the unsafe distance wD between two following-vehicles in real-time driving in order to provide a long and variable TTC of 2.4 s to 3.3 s between the two vehicles. The TTC that results from the value wD is proportional to established perception-reaction time (prT) of following drivers (about 1.5 s) and is proportional to speed, relative speed and braking distance of the two following-vehicles as it will now be shown in this disclosure. The useful and research [6] supported values of the TTC can be used to implement forward and backward collision warning systems on the host vehicle Y.

Most of the available automotive radar sensors provide the speed of their host vehicle (Y) and the relative speed between the Y and another vehicle that is, a vehicle (FV) that follows the Y or a lead-vehicle (LV) that is followed by the host vehicle Y. A preferred embodiment of the system may be coupled with an adapted backward-looking speed sensor (or radar) which may provide both the speed vY of its host vehicle Y and backward relative speed vR between the host vehicle Y and the vehicle FV that follows the Y. The system then calculates the missing speed vF of the FV as the vF=vR−vY. The system may also be coupled with an adapted backward-looking distance sensor (or radar) in order to measure backward relative distance (radD) between the host vehicle Y and its following-vehicle FV.

The preferred embodiment of the system may also be coupled with an adapted forward-looking speed sensor (or radar) which may provide speed vY of the host vehicle Y and forward relative speed (vR) between the host vehicle Y and the vehicle LV that leads the Y. The system then calculates the missing speed vL of the LV as the vL=vR−vY. The system may also be coupled with an adapted forward-looking distance sensor (or radar) in order to measure forward relative distance (radD) between the host vehicle Y and its lead-vehicle LV. If the backward-looking and forward-looking radars provide the speeds vF and vL respectively, then the system calculates the formula 1 by directly using the provided speeds vF and vL instead of calculating the speeds from the relative speeds which was shown here.

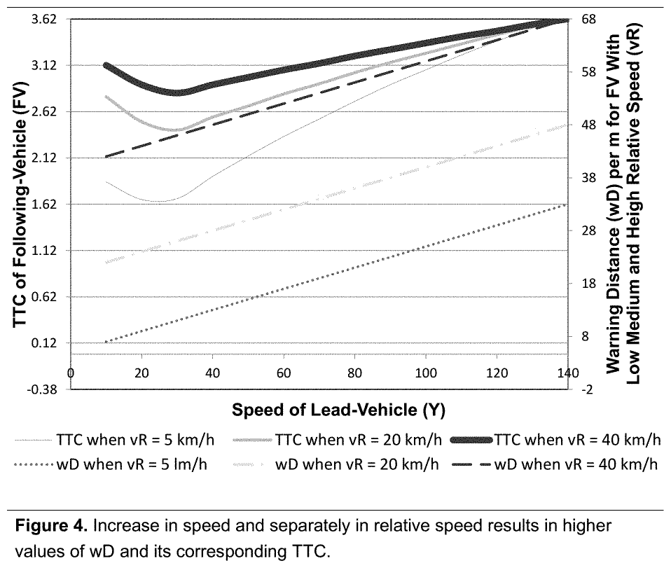

Referring FIG. 6, the system 200 can be described by method 100 for generating unsafe distance and low-speed warning pulses. The Method 100 is a process performed by the unsafe distance warning pulse generator 200 for generating the STTC pulses, low-speed pulses and safe zone pulse.

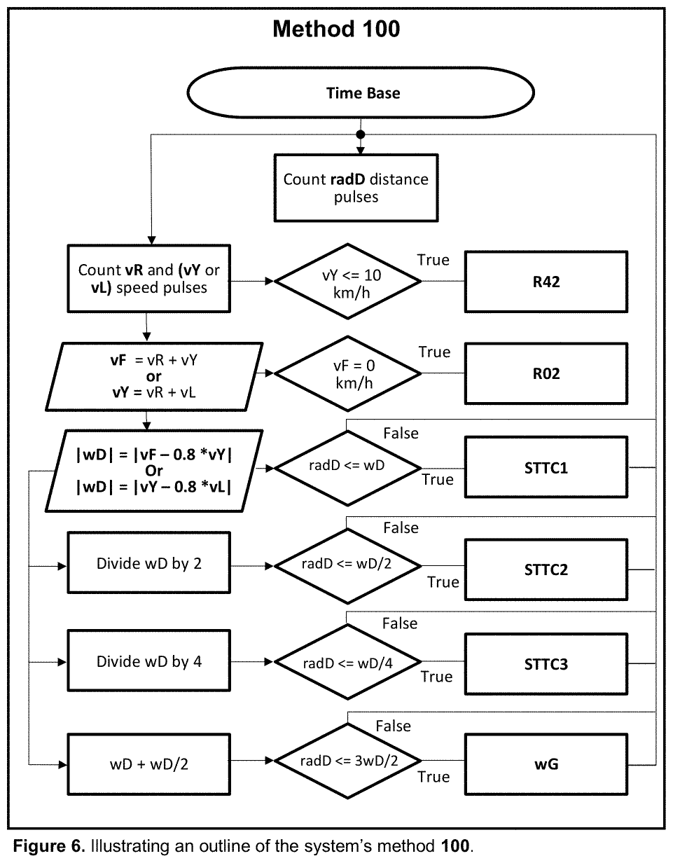

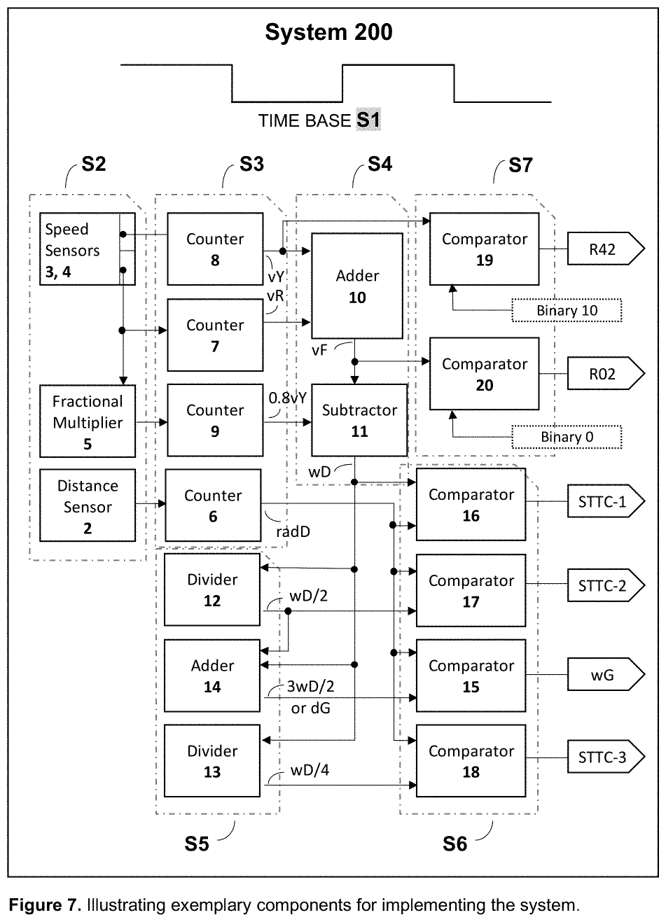

Referring to FIG. 8, the system 400 can be described by the reference speed method 300 for generating distance reduction warning pulses. The Method 300 is a process performed by the distance reduction rate pulse generator 400 for generating the forward and backward distance reduction rate pulses.

When the systems 200 and 400 receive backward speed and distance pulses from backward-looking radar sensors that are installed on the rear side of a vehicle that hosts the systems, the systems 200 and 400 generate unsafe backward distance warning pulses, distance reduction warning pulses and low-speed pulses. When the systems 200 and 400 receive forward speed and distance pulses from forward radar sensors that are installed on the front side of a vehicle that hosts the systems, the systems 200 and 400 generate unsafe forward distance warning pulses and distance reduction warning pulses.

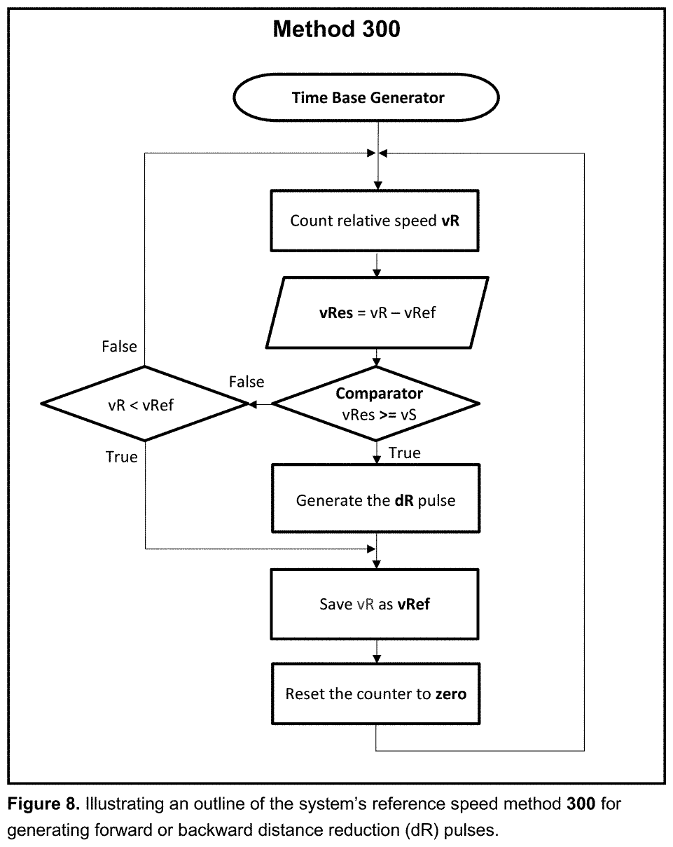

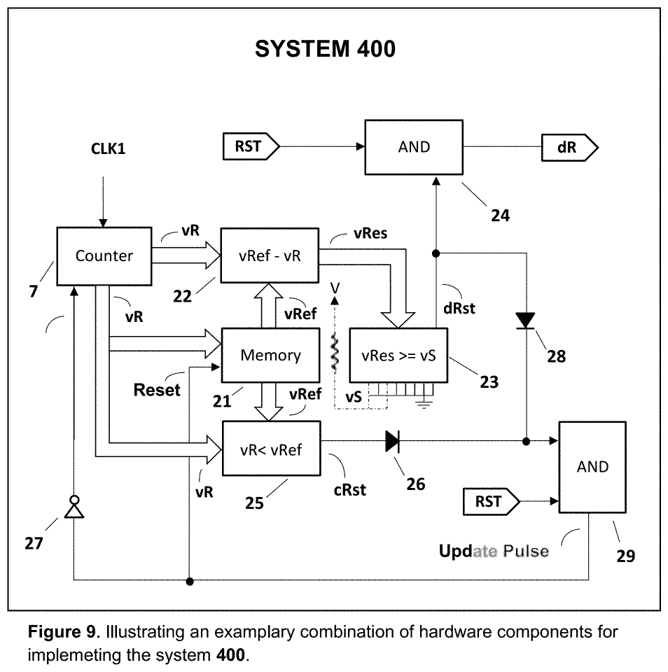

Referring to FIG. 10 and FIG. 11, the system 600, which is comprised of the systems 200 and 400, can be described by method 500 for generating the unsafe backward distance warning pulses, the distance reduction warning pulses and the low-speed pulses.

The Method 500 is a process performed by the system 600 for generating a number of warning pulses as the backward unsafe distance pulses, the low-speed pulses, safe zone pulse and distance reduction rate warning pulses for implementing Distance Warning and Signalling System (DWSS) as backward collision warning system (DWSS-BCW).

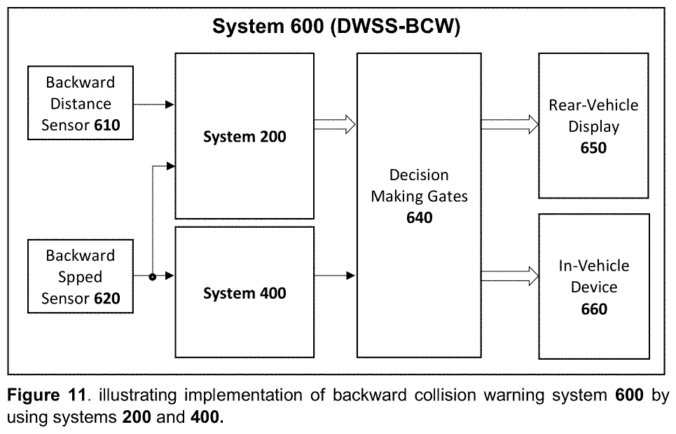

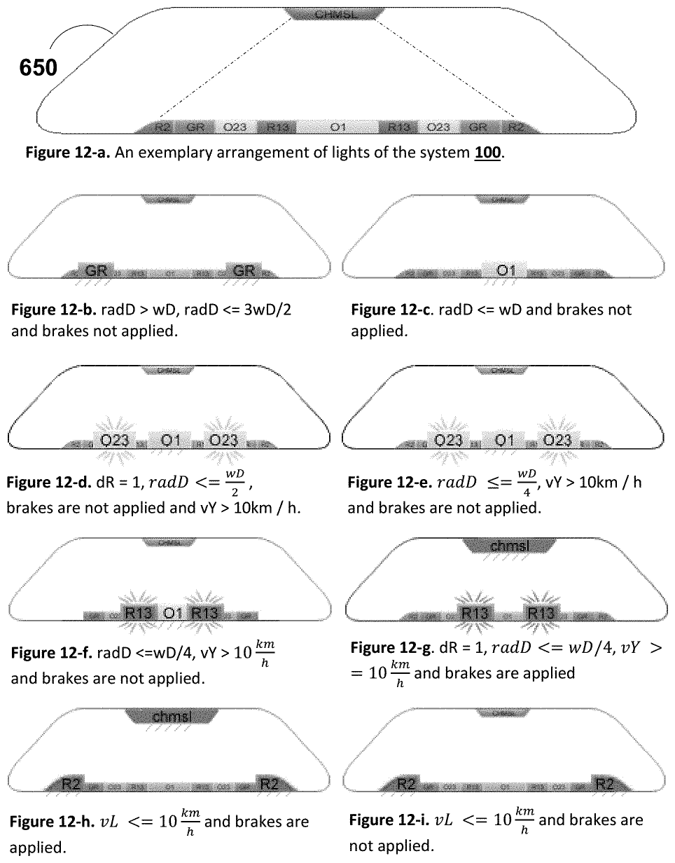

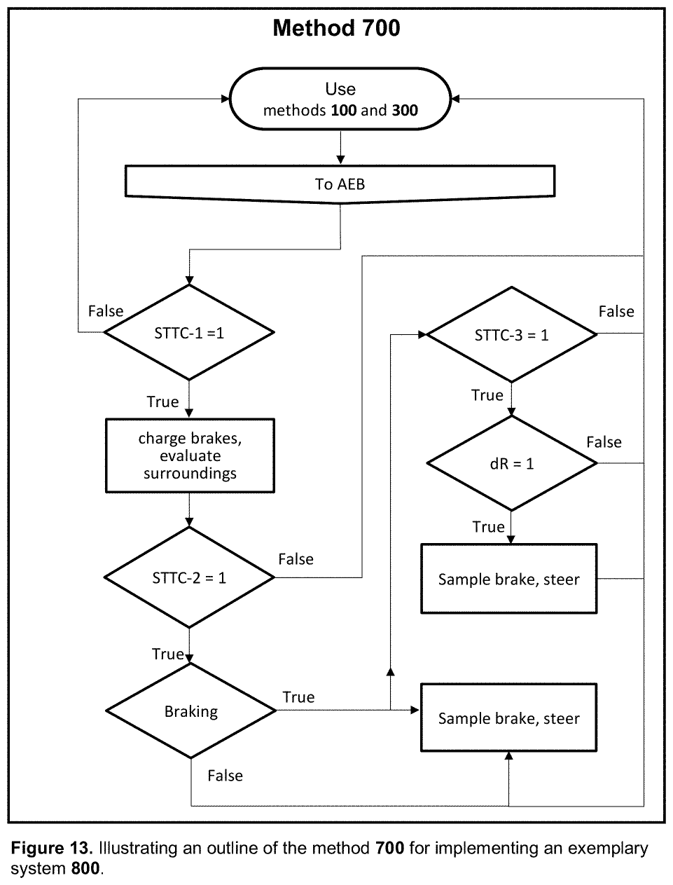

Referring to FIG. 13 and FIG. 14, the system 800, which like the system 600 is comprised of the systems 200 and 400, can be described by method 700 for implementing Distance Warning and Signalling System (DWSS) as forward collision warning system (DWSS-FCW). The Method 700 is a process performed by the system 800 for generating a number of warning pulses as the forward unsafe distance pulses, the low-speed pulses, safe zone pulse and distance reduction rate pulses for implementing Distance Warning and Signalling System (DWSS) as forward collision warning system (DWSS-FCW). The system 800 is considered to be a forward collision warning system DWSS-FCW because it amplifies and transfers its generated forward unsafe warning pulses to an Autonomous Emergency Braking (AEB) system that is coupled with its host vehicle to assist the AEB with braking and steering. FIG. 15 is a block diagram of a system 900 which illustrates preferred embodiment of the system as it is comprised of the backward Collison warning system 600 and substantially the forward collision warning system 800.

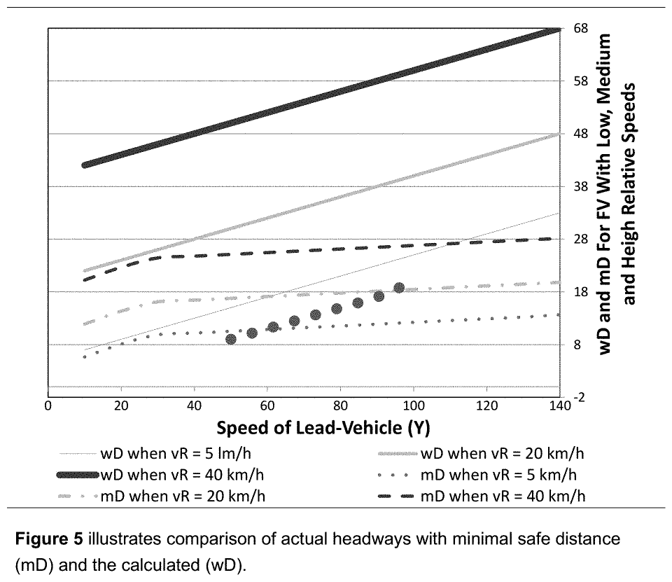

Referring to the FIG. 7 and FIG. 6, the system 200 can also be described in terms of assemblies of components that perform various functions for generating the unsafe distance warning and low-speed pulses by the system 200.

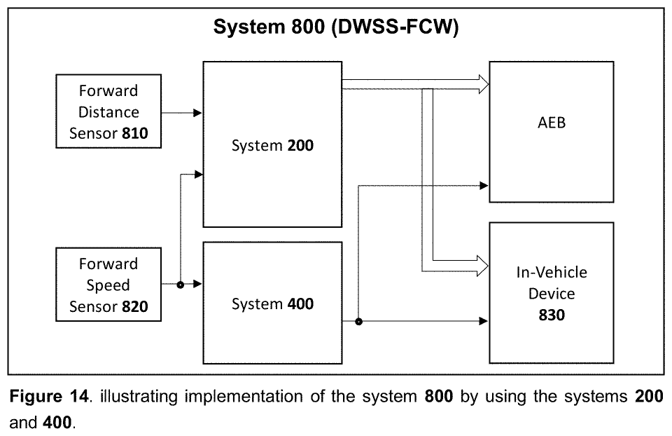

Referring to the FIG. 16, the system 400 can also be described in terms of assemblies of components that perform various functions for generating distance reduction warning pulses (dR) by the system 400.

The system 600 can also be described in terms of assemblies of the system 200 and substantially the system 400 and components that perform various functions for implementing the backward collision warning system (DWSS-BCW).

The system 800 can also be described in terms of assemblies of the system 200 and substantially the system 400 and components that perform various functions for implementing the forward collision warning system (DWSS-FCW).

Referring to the FIG. 15, the system 900 can be described in terms of assemblies of the system 600 and substantially the system 800 and components that perform various functions in support of the operation of the system 900. Because the functions of each of the systems 600 and 800 are based on the functions of the system 200 and substantially the system 400, the functions of the system 200 and substantially the system 400 constitute the core functionalities of the system. After the system generates its warning pulses, they can be used for implementing forward and backward collision warning systems.

2.1. DWSS as Backward Collision Warning System 500 (DWSS-BCW)

The system is comprised of an implementation of the method 100 as the system 200 for generating the unsafe distance warning, distance reduction and low-speed pulses. The system implements equal time intervals (TI) and receives speed and distance pulse frequencies from its coupled backward speed and distance sensors. During each of the time intervals, the system counts speed and distance sensor pulses. At the end of each of the time intervals, the system determines the speeds vY of its host vehicle (Y) and speed vF of a vehicle (FV) that follows the Y as binary numbers and implements the logic of the novel formula 1 as |wD|=|vF−0.8*vY| to calculate a backward distance wD as a binary number. At the end of each of the time intervals, the system also determines backward radar measured distance (radD) between the two following-vehicles FV and Y as a binary number.

At the end of each of the time intervals the system compares the binary representation of the calculated backward wD with the binary representation of the backward radar measured distance radD. If the system realizes from the comparison that the radD is less than or equal to the calculated value of wD, the system considers the radD as unsafe warning distance between the FV and the Y, and the system generates an unsafe distance warning STTC-1 pulse to define the onset of first stage of the calculated unsafe backward distance wD at the end of a time interval TI.

The system is comprised of magnitude comparator for comparing binary representation of the calculated value of the unsafe distance wD with binary representation of the measured distance radD at the end of each of the time intervals. The output of the comparator results in generating a pulse (STTC-1) for dynamically defining onset of the Time-to-Collision (TTC) that corresponds to the calculated wD between the two following-vehicles. The system generates the STTC-1 pulse while the system realizes from the comparison that the measured relative distance radD is less than or equal to the calculated unsafe distance wD at the end of a time interval. The onset of the STTC-1 pulse denotes that the FV has reached threshold of the calculated unsafe backward distance wD or threshold of the TTC between the FV and the Y.

Whenever the system generates a binary number as the backward wD at the end of a time interval, the system immediately divides the calculated wD by 2 and by 4 for producing a binary number equal to the value of (wD/2), and a binary number equal to the value of (wD/4) at the end of the time interval. The system also adds the wD and the wD/2 to generate a binary number (dG) at the end of the time interval.

At the end of each of the time intervals, the system compares the binary representation of the calculated dG with the binary representation of the backward radD. If at the end of a time interval the system realizes from the comparison that the radD is less than or equal to the calculated value of dG and the radD is greater than the calculated wD, the system considers the distance between the two vehicles a proximity and generates a pulse wG. When brakes are not applied on the host vehicle Y and the pulse R42 is not generated, the system uses the wG pulse for substantially illuminating a green light (GR) on the rear side of the host vehicle Y. The green light will define a safe green zone between the FV and the Y. The green zone which highlights the close proximity of the following-vehicle FV from the host lead-vehicle Y may also be considered an unsafe distance because only after the FV enters the green zone, at any moment the FV can enter the actual unsafe distance wD or the TTC determined by the calculated wD.

Every time the system generates a new STTC pulse, the previous stage of unsafe distance wD and its corresponding TTC is ended and a new unsafe stage is defined by the system. At the end of each of the time intervals, the system also compares the binary representation of the calculated wD/2 with the binary representation of the backward radD for generating an unsafe backward distance warning STTC-2 pulse if the system realizes from the comparison that the radD is less than or equal to the calculated value of wD/2 at the end of a time interval. The onset of the STTC-2 denotes that the FV has reached the threshold of the wD/2 at the third quarter of the calculated unsafe distance wD and ends the first stage of the STTC. The onset of the STTC-2 pulse defines the onset of the second stage of the unsafe backward distance wD between the two vehicles FV and Y at the end of the time interval. As illustrated in FIG. 2 and FIG. 3, the second stage lasts while the STTC-2 pulse is generated and a subsequent STTC is not generated.

At the end of each of the time intervals, the system also compares the binary representation of the calculated wD/4 with the binary representation of the backward radD for generating an unsafe backward distance warning STTC-3 pulse if the system realizes from the comparison that the radD is less than or equal to the calculated value of wD/4 at the end of a time interval. The onset of the STTC-3 pulse defines the onset of the third stage of the unsafe backward distance wD between the two vehicles FV and Y at the end of the time interval and ends the second stage of the STTC or unsafe distance.

In order to describe how the system generates its novel distance reduction pulses, a brief comparison between the DTL system and the present DWSS system is now made. Considering the DTL, at the end of equal time intervals, it received speed sensor pulses of the vehicle on which the DTL was installed in order to produce a pulse A whenever speed of the host vehicle was reduced by a predetermined unit of speed such as 3 km/h, and to produce a pulse B whenever the speed of the host vehicle was increased by as much as a predetermined unit of speed. The DTL subtracted speed of the host vehicle at the end of each equal time intervals from a previous speed of the vehicle (or reference speed stored in a memory at the end of a previous time interval) to realize whether speed of the host vehicle was decreased by the predetermined unit of speed or not in order to generate the pulse A at the end of a time interval.

Unlike the DTL, at the end of equal time intervals, instead of monitoring the speed of the host vehicle Y on which the system is installed, the system monitors increase in the relative speed of its host vehicle Y and a vehicle FV that follows the Y. The system substantially includes an implementation of the reference speed method 300 as the system 400 for realizing whether the speed of its host vehicle Y is increased by as much as a predetermines sample speed (vS) km/h or not at the end of a time interval. As a matter of fact, the decrease in the distance of the following-vehicle FV from its lead-vehicle Y is proportional to an increase in the relative speed vR between the two vehicles. Whenever the host vehicle Y decelerates or backs up, or whenever the FV accelerates, the vR between the two following-vehicles is accelerated and the distance between the two vehicles is reduced.

Factually, an increase in the vR by as much a predetermined sample speed (vS) km/h denotes a decrease of (d) meters in the distance between the two vehicles. The d meters is equivalent to the distance that the FV travels at vS km/h during a number of the equal time intervals until the system of the host vehicle Y realizes by its reference speed method 300 that the relative speed between the two vehicles is increased by as much as the vS km/h. Whenever the system realizes that the backward relative speed is increased by the vS km/h, or in other words, whenever the system realizes that the backward relative distance between the FV and its host lead-vehicle Y is reduced by the d meters, the system generates a backward distance reduction (dR) pulse. If the system has already generated an unsafe backward STTC pulse, the system amplifies and transfers the backward dR pulses to the housing of lights 650 for flashing an orange or red light for indicating to the driver of FV the distance reduction of the FV from its lead-vehicle Y. The system is coupled with a housing of lights 650 which includes lights of different colors. The system amplifies the STTC and the dR pulses and transfers them to the lights of the system for generating unsafe backward distance signals and distance reduction signals by illuminating and/or flashing the lights of different colors.

Unlike the DTL, the frequency at which the system generates the dR pulses signify the rate of decrease in distance between the two vehicles rather than signifying any changes in the speed of the host vehicle alone, which may be insignificant in many situations. Moreover, the dR pulses are generated only within the calculated unsafe distance wD when an STTC pulse is generated. Thus, the functions of the lights of the system result in a fundamentally different rear-signalling outcome than those of DTL. So that, only within the calculated unsafe distance swD, the faster the distance of the FV is reduced from the Y, the faster the dR pulses are generated to flash a warning light of the system faster on the rear side of the host vehicle Y. Thus the rate at which the warning lights of the host vehicle flash by the dR pulses indicate the rate of decrease of distance of the following vehicle from its host lead-vehicle.

Referring to the FIGS. 2, 3 and 12-g, the system uses the backward dR pulses for producing flashes of red warning light (R1) during any of the three stages of the STTC within the calculated wD distance. The system flashes the red light R1 if a) the brakes are being applied on the host vehicle Y; b) speed of the Y is greater than or equal to a predetermined speed such as 10 km/h; c) the system generates said dR pulses while the system is generating the STTC-1 pulse. The flashes of the R1 warn the driver of the FV about the rate of increase in the backward relative speed vR or the rate of decrease in distance radD of the FV from the Y by braking; so that the quicker the distance radD between the two vehicles is reduced, the faster the red light R1 flashes on the rear of the Y to indicate the rate of decrease in said radD between the FV and the Y.

When brakes are not applied on the host vehicle Y, the system uses the backward STTC-1 pulse to end the green zone by turning off the green light GR if it is on and illuminating an orange warning light (O1) in order to alert the driver of the FV that the FV is travelling within the unsafe distance wD from the Y. Referring to the FIG. 2 and FIG. 3, while the first stage lasts, the system flashes an orange light (O2) every time the system generates the backward dR pulse while brakes are not applied on the vehicle Y. The orange warning lights encourage the driver of the FV to reduce speed and stay within the green zone that is prior to the first stage of the backward STTC. So that, if the Y brakes hard for an emergency to stop, the FV has enough distance and time to react accordingly before reaching the short TTC of its AEB. While brakes are not applied on the host vehicle Y, the system maintains the orange warning light O1 illuminated during the three stages of the backward STTC.

The driver of the FV may miss the warning signals of the orange lights O1 and O2 and may reach the threshold of the unsafe distance wD and the system may generate the STTC-2 pulse. The onset of the STTC-2 ends the first stage of the unsafe distance wD for preventing the orange light O2 from flashing. While the second stage lasts, the system flashes an orange light (O3) at a fixed frequency of 2 Hz within the third quarter of the wD for warning the driver of the FV that the FV is dangerously close to its lead-vehicle Y while the Y is not braking. The orange light O3 encourage the driver of FV to increase the distance of the FV from the host vehicle Y.

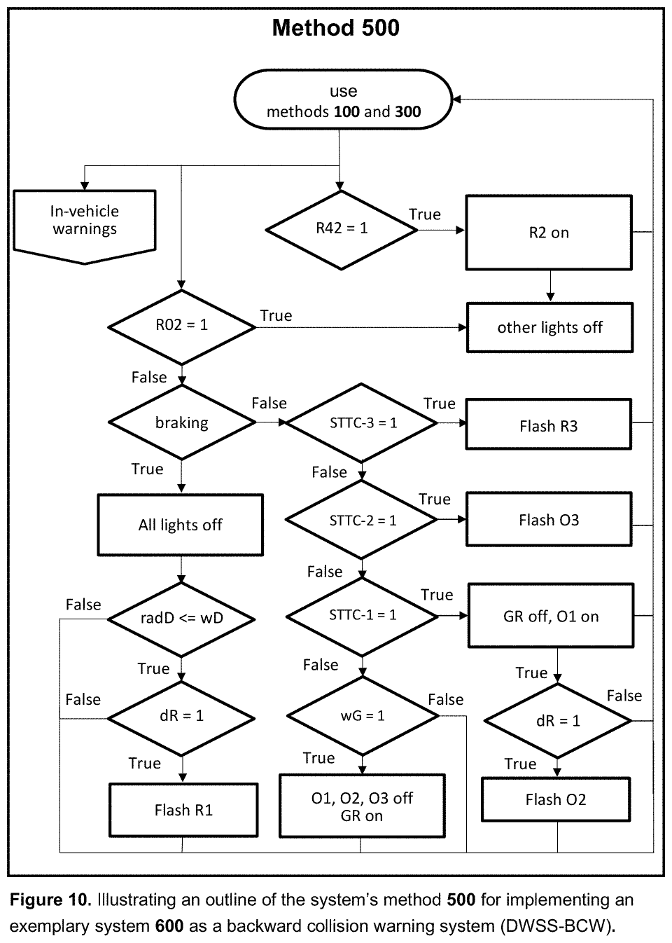

If the driver of FV also misses the warning signals of the orange light O3 and enters the third stage of the unsafe distance wD in the last quarter of the calculated wD, the system of the Y generates the STTC-3 pulse for defining the third stage of the unsafe distance wD and ending the second stage for turning off the O3. The third stage of the unsafe backward distance wD lasts while the STTC-3 pulse pulse lasts. Referring to the FIG. 2, the FIG. 3 and the FIG. 12-f, if brakes are not applied on the vehicle Y, the system uses the STTC-3 pulse for activating flashes of a red light (R3) at a fixed frequency of 3 Hz. The flashes of the R3 are intended to strongly discourage and stop the dangerous tailgating to prevent a hazardous situation while the third stage of the STTC lasts. Simultaneously, if the FV has reached the TTC threshold of its AEB, the latter can decide to brake or not if driver of the FV does not reduce its distance from the Y.

Referring to the FIG. 3 and FIG. 12-h, if while the brakes are applied on the vehicle Y the speed of the Y is less than a predetermined speed such as 10 km/h, the system does not flash the red light R1 and instead it turns on two stoplights R2 to form a triangular stop sign with the standard CHMSL on the rear of the host vehicle Y for indicating that the host vehicle is stationary. Even more prominently, when red lights are on and do not flash on the host vehicle Y, they imply stationary state of the host vehicle Y.

The system restricts the signalling functions of its orange and red lights to within its calculated unsafe distance wD or to the duration that the system generates any of its STTC pulses. The restricted functions of the system will help drivers to be more responsive towards the signalling of the system and to maintain safer headways. The latter also allows the following-drivers and the AEB of their vehicle to reduce emergency braking which results in reduced traffic crashes.

Referring to the FIG. 3, when the vehicle FV follows the vehicle Y too closely and the warning signals of the system of the host vehicle Y are activated, the driver of a third vehicle (FV3) that follows in an adjacent lane also perceives the warning signals of the system on the host vehicle Y. So that the driver of FV3 can have better information as to whether change lane and position the vehicle FV3 between the other two vehicles or not.

In another embodiment (embd2) of the system, the cost of construction of the housing of lights 650 is reduced by using one light to perform more than one function. The system of such embodiment uses only one orange light (O123) to implement the functionalities of the orange lights O1, O2 and O3, and only one red light (R123) to implement the functionalities of the red lights R1, R2 and R3. In this embodiment, the system uses the orange light O123 to perform the function of the orange light O1 by keeping the O123 illuminated as long as the STTC-1 pulse is generated, the STTC-2 is not generated and the brakes are not applied. The system uses the orange light O123 to perform the function of the orange light O2 by flashing the O123 per each of the dR pulses during the first stage of the TTC as explained with the functionality of the orange light O2. The system of the embd2 also uses the orange light O123 to perform the function of the orange light O3 by flashing the O123 at the fixed rate of 2 Hz within the second stage of the STTC as explained with the functionality of the O3. The system of this embodiment uses the red light R123 to perform the function of the red light R1 by flashing the R123 each time the system generates a dR pulse and brakes are applied as explained with the functionality of the red light R1. The system uses the red light R123 to also perform the function of the red light R3 by flashing the red light R123 at a constant rate of 3 Hz within the third stage of the STTC if brakes are not applied as explained with the functionality of the R3. This system uses the red light R123 to also perform the function of the red light R2 by keeping the red stoplight R123 illuminated without flashing when the speed of host vehicle Y is less than or equal to 10 km/h as explained with the functionality of the R2. So that an illuminated red light R123 without flashing implies that the host vehicle is stopped.

If there exists a light (cL) that can change color based on different input signals to its accompanied control device, then another embodiment of the system (embd3) will substantially replace the lights of its exemplary housing of light 650 with the cL.

The system substantially uses separate electric wires to transfer all of its backward pulses wG, dR, STTC-1, STTC-2 and STTC-3 to the inside of the vehicle Y. The system substantially uses the backward pulses to activate a coupled in-vehicle audio-visual device to alert the driver of the Y about how close the FV is from the host vehicle Y and how fast the FV is approaching the Y. For example, the system may include an orange light and a red light inside the host vehicle Y to be turned on or flashed when the orange light O1, O2 or O3 or the red light R1 or R3 turn on or flash on the rear of the Y. The in-vehicle audio-visual device may also have means to create a short buzzer sound each time the orange or red warning lights are turned on flashed.

The generated pulses could also have other uses. For example, the system of the host vehicle Y could transmit the pulses to other electronic devices in the FV so that the two vehicles could communicate and the FV could take an appropriate action for increasing its distance from its lead vehicle.

2.2. DWSS as Forward Collision Warning System 700 (DWSS-FCW)

The system is substantially comprised of a second implementation of the method 100 as the system 200 and a second implementation of the method 300 as the system 400 for generating unsafe forward distance warning pulses (STTC) and forward distance reduction (dR) warning pulses. In the second implementation, instead of the backward speed and distance radar sensors, the system is coupled with forward speed and distance radar sensors for generating its warning pulses.

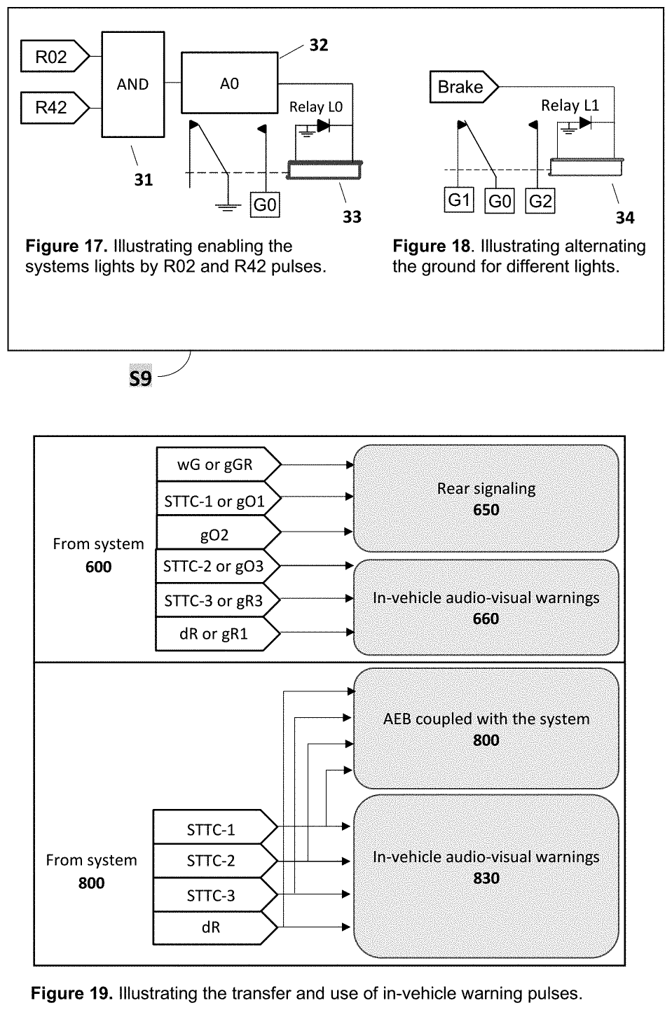

After the system generates the forward STTC and dR warning pulses, the pulses can be used in order to improve traffic safety between the host vehicle Y and its lead vehicle LV. For example, referring to the FIG. 19, the system can substantially use its generated STTC and dR pulses to activate an in-vehicle audio-visual warning device 830 to generate one short signal to inform the driver of the host vehicle Y about hazards with the unsafe distance of the Y from its lead-vehicle LV. The forward STTC and dR pulses can also be used to support other vehicle safety devices of the vehicle that hosts the system. For example, while an inattentive driver of a host vehicle (Y) continues to approach its lead-vehicle (LV) within the calculated unsafe forward distance wD, a custom-made device or an adapted device of the Y can use the forward STTC and dR pulses to support the operation of driving assistance systems of the vehicle Y such as Autonomous Emergency Barking (AEB) systems. The system substantially transfers its generated forward STTC and dR pulses through electric wires to an input receiver of an adapted AEB system that is coupled with the system on the host vehicle Y to support the AEB with braking and steering.

FIG. 13 illustrates an example using the system's forward STTC and dR pulses to support the AEB by:

Providing the STTC-1 pulse as brake and steer input control reference pulse for the AEB on the onset of the first stage of the calculated unsafe forward distance so that the AEB can autonomously decide how and when to apply brake and/or steer pressure on the brake and/or steer controls of its host vehicle Y. The AEB can decide whether to charge the brakes and steer controls in preparation for possible emergency braking or steering maneuver if the host vehicle Y continues to approach the LV critically during next stages of its defined STTC. Simultaneously, the AEB can be triggered by the STTC-1 pulse to evaluate the surroundings in advance before the host vehicle Y reaches the TTC of its AEB;

Providing the STTC-2 pulse as brake and steer input control reference pulse for the AEB on the onset of the second stage of the calculated unsafe forward distance so that the AEB can decide whether to apply a predetermined sample pressure on brakes and/or steer controls of its host vehicle Y in order to moderately reduce the speed of the Y or to steer the Y;

providing the AEB by the STTC-3 and dR pulses on the onset of the third stage of the calculated unsafe forward distance so that the AEB can also use the pulses in its decision-making process for applying the sample pressure on the brake pedals and/or steer controls of its host vehicle Y per each of the dR pulses that it receives. So that, the quicker the system generates and transfers the consecutive forward distance reduction dR pulses to the AEB, the more consecutive and incremental braking or steering may be applied by the AEB on its host vehicle. This way, the AEB of the host vehicle Y can know intuitively from the frequency of the provided distance reduction dR pulses (and without critically relying on its software computations) that how to effectuate necessary braking or steering on the Y in order to prevent the host vehicle Y from a collision.

Since the system is an electronic-only system, the warning pulses STTC-1, STTC-2, STTC-3 and dR of the system are more reliable for activating an adapted AEB system than systems which feature software. In another embodiment (embd4) of the system, the system may include additional binary dividers and magnitude comparators for calculating additional fractions of the wD such as wD/8 in addition to the wD/2 and the wD/4. This system then compares the additional fractions with the radar measured distance radD between the two trailing vehicles for producing additional STTC pulses. This way, the embd2 of the system defines additional stages of the TTC and uses the additional STTC pulses to implement additional warning signals and to implement more stages of braking or steering supports for its coupled AEB.

3. System's Hardware

When the system is coupled with an adapted forward-looking speed and distance radars, the system is comprised of an implementation of the systems 200 and 400 for generating the forward STTC and dR pulses. When the system is coupled with an adapted backward-looking speed and distance radars, the system is comprised of an implementation of the same systems 200 and 400 for generating the backward STTC and dR pulses. Therefore, the systems 200 and 400 constitute the core functionalities of the system as the backward collision warning system 600 (DWSS-BCW) and as the forward collision warning system 800 (DWSS-FCW). Thus this disclosure emphasises only on the details of the hardware of the systems 200 and 400 for generating the backward STTC and dR pulses between a host lead-vehicle (Y) and its following-vehicle (FV).

The system is comprised of digital and analogue electronic components which are coupled with speed and distance radar sensors. All electronic components of the system are powered through a voltage regulator which is powered by the host vehicle's battery. All lights of the system are also powered by the host vehicle's battery.

Today, there are a variety of automotive radar systems from different manufacturers in the market. The radars provide different output frequencies of pulses as speed and distance of vehicles. In the preferred embodiment of the system, a backward speed radar sensor and a backward distance radar sensor are coupled with the system to provide:
1) frequency of pulses (vrF) of relative speed of the host lead vehicle Y and its following vehicle FV; where the relative speed of the Y and its following vehicle FV is referred to as backward relative speed vR;
2) frequency of pulses (vyF) of the speed of the host vehicle Y; and
3) frequency of pulses (distF) of distance between the two vehicles FV and Y.

The electronics of the system are comprised of few sections which are comprised of a number of semiconductor and other electronic components. The FIG. 7 and FIG. 16, illustrate the hardware implementation of the pulse generator system 200 of the system. The latter is comprised of a first section that includes electronic circuitry of general knowledge for implementing the time base generator 1 (TB) for generating equal time intervals (TI). In a preferred embodiment of the system, the system uses a preferred 20 Hz time base generator to implement equal time intervals TI of preferably 0.05 second. The system defines the time intervals by generating a reset (RST) pulse with regular intervals of 0.05 second. The system counts the pulses that it receives from its coupled speed and distance radar sensors during each of the time intervals TI that is between two subsequent RST pulses. In another embodiment of the system (embd5), the system may adapt its time base generator in order to produce longer time intervals such as 0.1 s or shorter time intervals such as 0.01 s although with shorter time intervals, the system may miss to count some speed and distance pulses because of latency.

The frequency of pulses that the system receives from a selected distance and speed radar must be customized to be a multiple of the time base frequency generated by the time base generator. So that, at the end of each of the TIs, each speed pulse substantially represents 1 km/h of speed and each distance pulse substantially represents 1 meter of distance between the two vehicles. This way, (a) the number of speed pulses vyF that the system counts by the end of each of the time interval represent the actual speed vY of the vehicle Y; (b) the number of relative speed pulses vrF that the system counts by the end of each of the time interval represent the actual relative speed vR between the Y and the FV; and (c) the number of distance pulses distF that the system counts by the end of each of the time interval represent the actual distance radD between the two vehicles per meters. Consequently, the electronics of the preferred system calculate the speed (vF) of the FV as vF=vrF−vY for providing a value for the variable vF in the novel formula 1.

Referring to the FIG. 7 and FIG. 16, the system is comprised of a second section that includes:
a) distance sensor 2 for providing relative distance frequency distF=(k*TB*radD) Hz between the two vehicles Y and FV;
b) speed sensor 3 for providing relative speed frequency vrF=(m*TB*vR) Hz between the two vehicles; and
c) speed sensor 4 for providing speed frequency vyF=(n*TB*vY) Hz of host vehicle. Where the TB is set to be 20 as the system generates 20 time-intervals per second and the k, m and n are constants >=1 depending to the sensor manufacturer's specifications. The preferred embodiment of the system uses customized radar sensors which provide such input pulse frequencies where the k, m and n are equal to 1 when TB=20 for providing the distance and speed of the vehicles as a multiple of 20 every second. So that, at the end of each of the TIs of 0.05 s, each speed pulse represents 1 km/h of speed and each distance pulse represents 1 meter of distance between the two vehicles.

In another embodiment of the system (embd6), the coupled radar sensors are adapted so that they provide such frequencies that the constant k, m or n is greater than 1. Consequently, the system of the embd6 is comprised of an additional section for dividing the distance or speed frequency of pulses that it receives as input from its host vehicle, with their associated constant k, m or n. This way, the distance and speed sensors can provide the distance, relative speed, and speed frequencies of the host vehicle as a multiple K, m or n of the TB every 0.05 s rather than strictly as multiple one of the TB.

The preferred embodiment of this system uses metric units of speed and distance to implement the logic of the formula 1. In another embodiment of the system (embd7), the system uses empirical units of speed and distance to implement the logic of the formula 1. In such embodiment of the system, the speed and distance sensors are adapted so that the coefficients m, n and k are such values that the system's implementation of the formula 1 produces reasonable values as the calculated unsafe distance wD.

The second section of the preferred embodiment of the system also includes a fractional frequency multiplier 5 that is configured to output 8 pulses per each 10 pulses of the vyF frequency that it receives at its input for providing the 0.8 fraction of the vyF speed frequency (frac_vyF) at the end of each of the time intervals. The system needs the frac_vyF to provide the measured fraction of the speed vY of the host vehicle Y or 0.8*vL at the end of each of the TIs (as it will now be explained) for implementing the logic of the novel formula 1. An example of such fractional multiplier is Texas-Semiconductor CD4527B Types.

Referring to the FIG. 7 and FIG. 16, the system is comprised of a third section for counting its input frequencies distF, vrF, vyF and frac_vyF for providing the measured radar distance radD, the relative speed vR, the speed vY and the 0.8 fraction of the vY at the end of each of the TIs; where the third section is comprised of:

A first frequency counter 6 for counting the distF pulses during each of the time intervals TI so that by the end of each of the TIs the counter holds a binary number (radD) representing the actual radar measured distance between the two vehicles per meter;

A second frequency counter 7 for counting the vrF during each of the TIs so that by the end of each of each of the TIs the counter holds a binary number (vR) representing the actual relative speed of the two vehicles per km/h, where the vR is provided to be greater than or equal to 0 km/h;

A third frequency counter 8 for counting the vyF during each of the TIs so that by the end of each of the TIs the counter holds binary number (vY) representing the actual speed of the Y per km/h; and

A fourth frequency counter 9 for counting said frac_vyF during each of the TIs so that by the end of each of the TIs the counter holds binary number (0.8vY) representing 0.8 percentage of the actual speed of the Y per km/h.

Referring to the FIG. 7 and FIG. 16, the system is comprised of a fourth section as arithmetic logic unit (ALU) for performing arithmetic operation on the binary numbers vF, vY and 0.8vY which are produced in the third section, where the fourth section is comprised of:

A binary adder 10 to add the binary numbers vR and vY that are present at the output of the binary counters 7 and 8 to provide a binary number as the speed (vF) of the FV at the end of each of the TIs, because from math the vR=vF−vY; and

A binary subtractor 11 for subtracting the binary number 0.8vL from the binary number vF for producing a binary number (wD) representing a calculated potential unsafe headway or distance as per the novel formula 1.

Thus, the effect of this method is that the values of the speed vY and the speed vF are dynamically assigned to the speed variables in the novel formula 1 in order to perform said arithmetic operations. This way the system produces the value of the |wD|=|vF−0.8*vY|.

In another embodiment of the system (embd8), the selected speed radar provides frequency of pulses (vfF) of speed of the FV instead of the frequency of pulses vrF of the relative speed vR. This system uses the counter 7 to count the number of vfF speed pulses instead of the vrF relative speed pulses during each of the TIs, so that the electronic circuit of the embd8 does not need the vR in order to calculate the vF. Instead, this system calculates the relative speed vR of the two vehicles as vR=vF−vY. This way, at the end of each of the TIs, the system of the embd8 gets the speed vF of the FV directly from the counter 7 and eliminates the binary adder 10. In the preferred embodiment of the system, the binary adder 10 is used as explained.

The preferred embodiment of the system monitors the relative speed vR for detecting increases in the vR by a predetermined speed sample (vS) such as 5 km/h by the end of any of the time intervals TI.

Referring to the FIG. 7 and FIG. 16, the system includes a fifth section for dividing the binary number wD in order to produce a number of fractions of the wD for generating the STTC pulses as it will now be explained; where the fifth section is comprised of:

A first binary divider 12 in order to divide the wD by 2 for generating a binary number (wD/2) whose value is equal to one half of the calculated wD;

A second binary divider 13 in order to divide the wD by 4 for generating a binary number (wD/4) whose value is equal to one forth of the calculated wD; and

A second binary adder 14 in order to add the wD/2 to the wD for generating a binary number (dG)=3wD/2 whose value is equal to three halves of the wD.

In another embodiment of the system (embd9), instead of using the semiconductors such as the frequency counters, dividers, binary adders and binary subtractors of the FIG. 16, the system uses a microcontroller processor to determine the distance and speeds of the vehicles at the end of each of the TIs. The system then uses a Direct Digital Synthesis (DDS) to produce the results of the required arithmetic operations for implementing the novel formula (1) or one of the variations of the formula 1 for producing the value of the wD.

Another embodiment of the system (emb10) eliminates the counter 7, counter 8, binary adder 10 and binary subtractor 11 and the system does not count the input frequencies vrF and vyF in the third section and does not perform the arithmetic operations of the ALU in section 4 on the binary representations of the counted frequencies. Instead, the system of the performs the arithmetic operations directly on the input speed frequencies vrF, vyF and fract_vyF and then the system counts the pulses of the resultant frequency. The system of the embd6 implements such electronic circuit by first combining (i.e.: adding) the two input frequencies vrF and frac_vyF to produce one frequency (vfF) of the speed vF of the vehicle FV. The system then combines (i.e.: subtracts) the frac_vyF from the vfF to produce a resultant frequency (wdF) representing (vfF−frac_vyF). This system uses a counter such as counter 7 to count the resultant frequency wdF during the equal time intervals. In order to combine (i.e.: add) the two input frequencies, the system first aligns the two input frequencies vrF and vyF and then uses a frequency adder composed of components such as logical XOR gates. In order to combine (i.e.: subtract) the frac_vyF from the vfF, the system uses a frequency subtractor composed of components such as dual flip flops. This way the system performs the arithmetic operations directly on the input speed frequencies to produce the frequency wdF and counts the wdF by the counter 7. So that at the end of each of time intervals, the counter 7 holds the value of the wD at its output pins where the wD in produced in accordance with the novel formula 1 or one of its variations by performing the arithmetic operations of the novel formula 1 on the input speed frequencies as explained.

In another embodiment of the system 400 (embd11), the system 400 may comprise the counter 6 instead of the counter 7 for monitoring reduction in the distance between the two tailgating vehicles by a predetermined sample speed such as 1 meter.

In another embodiment of the system (embd12), the system comprises of means for dynamically changing the value of the parameter n to a smaller or larger value in order to vary the length of the calculated TTC based on control pulses from other sensors of the vehicle. For example, when an in-vehicle sensor detects an impaired driver, the sensor may send such control pulse to the system for calculating the unsafe distance and its corresponding STTC values based on a smaller value for the parameter n similar to the calculations of the STTC for truck drivers as elaborated. Similarly, if other sensors of the vehicle realize unfavourable roads conditions such as icy road for example, the sensors can send such control pulses to the system so that the system uses a smaller value for the parameter n rather than its default value of 0.8. One way to accomplish dynamic changes of the value of the parameter n is to use the control pulses of other sensors of the host vehicle through logic gates for defining different values at inputs of the fractional multiplier of the system 200 based on the control pulses.

In another embodiment of the system (embd13), a pulse transmitter can be coupled with the forward distance warning and signaling system (DWSS-FCW) of vehicles. The transmitter can be used to send the generated warning signals of the DWSS-FCW system to a lead vehicle which features a paired receiver on its rear side. The receiver can be used to activate a backward collision warning system of the lead-vehicle upon receiving the signals. For example, the receiver of the lead-vehicle may activate rear signaling system of the lead-vehicle upon receiving the signals. A receiver on the rear of a lead vehicle maybe less costly than the DWSS-BCW system itself. However, all vehicles need to feature the DWSS-FCW and its transmitter so that the lead-vehicle can benefit from the transmitted signals of its following-vehicle.

Reversely, in another embodiment of the system (embd14), a pulse transmitter can be coupled with the backward distance warning and signaling system (DWSS-BCW) of vehicles. The transmitter can be used to send the generated warning signals of the DWSS-BCW system to a lead vehicle which features a paired receiver on its front side. The receiver can be used to activate a forward collision warning system of the lead-vehicle upon receiving the signals. For example, the receiver of the lead-vehicle may provide the received signals for Autonomous Emergency Braking (AEB) system of its host vehicle in order to support the AEB with its functions. However, all vehicles need to feature the DWSS-BCW and its transmitter so that the lead-vehicle can benefit from the transmitted signals of its lead-vehicle.

In all embodiments of the system, the system may provide few sequential pulses during a time base pulse cycle for controlling a selected counter IC such as 74hc163.

Referring to the FIG. 7 and FIG. 16, the system includes a sixth section for simultaneously comparing the magnitude of the calculated binary numbers dG, wD, wD/2 and wD/4 with the magnitude of the binary number representation of the radar measured distance radD where the sixth section is comprised of:
a) A first magnitude comparator 15 for comparing the counted binary number radD with the calculated binary number dG in order to produce the pulse wG if the magnitude of the radD is less than or equal to the magnitude of the dG;
b) A second magnitude comparator 16 for comparing the radD with the calculated binary number wD in order to produce a high STTC-1 pulse if the magnitude of the radD is less than or equal to the magnitude of the wD;
c) A third magnitude comparator 17 for comparing the radD with the calculated binary number wD/2 in order to produce a high STTC-2 pulse if the magnitude of the radD is less than or equal to the magnitude of the wD/2; and
d) A fourth magnitude comparator 18 for comparing the radD with the calculated binary number wD/4 in order to produce a high STTC-3 pulse if the magnitude of the radD is less than or equal to the magnitude of the wD/4;

Where the system uses the generated pulses wG, STTC-1, STTC-2 and STTC-3 to produce the unsafe distance warning signals as it will now be explained.

Referring to the FIG. 7 and FIG. 16, The system generates the reset pulses which last a few milliseconds in order to reset the counters 6, 7, 8 and 9 to zero for restarting to count the speed and distance pulses during subsequent time interval of 0.05 s. Resetting the counters results in low output at the output pins of the counters during the few milliseconds. This will result in a low STTC pulse at the outputs of the comparators 15, 16, 17 and 18 during the few milliseconds. Consequently, the system substantially uses an RC circuit (RC1, RC2, RC3, RC4) at the output of each of the comparators in order to briefly maintain the generated STTC and wG pulses at their high state while the distance between the two vehicles remain low and the STTC and wG pulses are generated. A preferred value for the resistor component in each of the RC circuits is 50 kΩ and a preferred value for the capacitor component in each of the RC circuits is 0.001 μf in order to maintain the high state of the STTC and wD pulses for 0.05 s when the reset pulses are generated.

Referring to the FIG. 7 and FIG. 16, the system also includes a seventh section which generates a high pulse R42 and a high pulse R02 as low-speed pulses for activating and deactivating its lights where the seventh section is comprised of:
a) A first magnitude comparator 19 whose one set of inputs are set to binary representation of a predetermined number such as 10 and whose other set of inputs are set to the binary number vY that is at the outputs of said counter 8. The comparator 19 compares the binary number vY with the binary representation of the predetermined 10 km/h speed in order to produce the pulse R42 if the magnitude of the speed vY of the vehicle Y is greater than the binary number 10. The system uses the pulse R42 to indicate that its host vehicle is stopped or almost stopped by turning on the stoplights R2 as it will now be explained; and
b) A second magnitude comparator 20 whose one set of inputs are set as a binary number 0 and whose other set of inputs are fed by the binary number vF that is at the outputs of said binary adder 10. The comparator 20 compares the speed vF of the vehicle FV with the binary number 0 in order to produce the pulse R02 if the magnitude of the speed vF is greater than the binary number 0. The system will use the pulses R42 and R02 to activate an electrical circuit which powers its warning lights as it will be now explained. When no vehicle follows the host vehicle Y or when the following-vehicle FV is stopped, the system deactivates all of its lights except its stoplights R2.

Referring to the FIG. 16, the preferred embodiment of the system includes an eighth section that is comprised of an implementation of the reference speed method 300 as the system 400 for monitoring increase in the speed vR by a predetermined speed sample (vS) such as 5 m/h (i.e.: 1.4 m/s). As opposed to the DTL which saved the speed vY of its host vehicle as reference speed (vRef) at the end of a time interval, the preferred embodiment of the system saves the relative speed vR as the reference speed vRef in the memory 21 to be available at its output pins at the end of a subsequent time interval. When the system is activated, the system continuously feeds the binary number vR that is at the outputs of the counter 7 to one set of inputs of a memory (latch) 21 and a binary subtractor 22.

As opposed to the DTL, the preferred embodiment of the system reverses the inputs of its subtractor 22 so that, at the end of each of the TIs, instead of subtracting the speed vY from the vRef which was saved in the memory 21 at the end of a previous TI, the system subtracts the vRef from the relative speed vR which was saved in the memory 21 at the end of a previous TI. This way the system can determine whether the vR is increased at least by a predetermined speed sample vS or not. In order to carry out this functionality, the system also continuously feeds the binary number vRef that is at the outputs of its memory 21 to the second set of inputs of the subtractor 22 and feeds the resultant (vRes) that is at the outputs of the subtractor 22 to one set of inputs of a comparator 23. The second set of inputs of the comparator 23 are set as a binary number representing the predetermined speed sample vS, so that at the end of each of the time intervals, the system compares the vS with the vRes in order to produce a high pulse (dRst) when the system realizes from the comparison that the vRes is greater than or equal to the vS.

Referring to the FIG. 16, the eight section of the preferred embodiment of the system also includes a logical AND gate 24 whose one input is fed by the reset RST pulse at the end of each of the TIs and whose second input is fed by the pulse dRst. If while the system is generating the dRst pulse at one of the inputs of the logical gate 24 the system also generates a RST pulse at the other input of the logical gate, the gate 24 produces a high pulse as the dR pulse at its output at the end of the time interval for the duration that the RST pulse lasts.

Whenever, at the end of a time interval, the system generates a high dR pulse to determine that the vR is increased by as much as a vS, or whenever the system realizes from comparison of the vR with the vRef that the vR is less than the vRef, the system should update the vRef that is stored in the memory to the newly counted value of the vR at the end of the time interval. Simultaneously, the system should reset the counter 7 to zero in order to restart counting the speed sensor pulses to repeat updating the vRef in the memory and resetting the counter when the conditions are met.

Referring to the FIG. 16, the eight section of the preferred embodiment of the system also includes a comparator 25 whose one set of inputs are fed by the binary number vRef and whose second set of inputs are fed by the binary number vR. The output of the comparator 25 is normally a low voltage. When the comparator 25 realizes from the comparison that the vRef is less than the vR, it generates a high pulse cRst at its output to indicate that the vRef is less than the vR.

The system feed the normally low output (cRst) of the comparator 25 and the dR pulse through a diode 26 and a diode 28 to one input of a logical AND gate 29. The system feeds the second input of the logical gate 29 by the RST pulse. If while the system is generating the high pulse cRst or the high pulse dR the system generates the RST pulse at the end of a time interval, the output of the logical gate 29 produces a high pulse (UPD) at the end of the time interval. The system applies the UPD pulse at reset pin of the memory 21 in order to update the reference speed vRef that was latched in the memory 21 at the end of a time interval. The low reset pulse updates the value that is held in the memory 21 to the latest value of the binary number vR that is present at the outputs of the counter 7 at the end of the same time interval when the system generates the UPD pulse.

Following updating the memory, the system must sequentially reset the counter 7 to restart counting the vrF speed sensor pulses in order to continue to monitor increase in the vR during subsequent time intervals. For this reason, the system inverts the UPD pulse by the inverter 27 for producing a low (Reset) pulse and feeds the inverted UPD pulse to the reset pin of the counter 7 with milliseconds of delay.

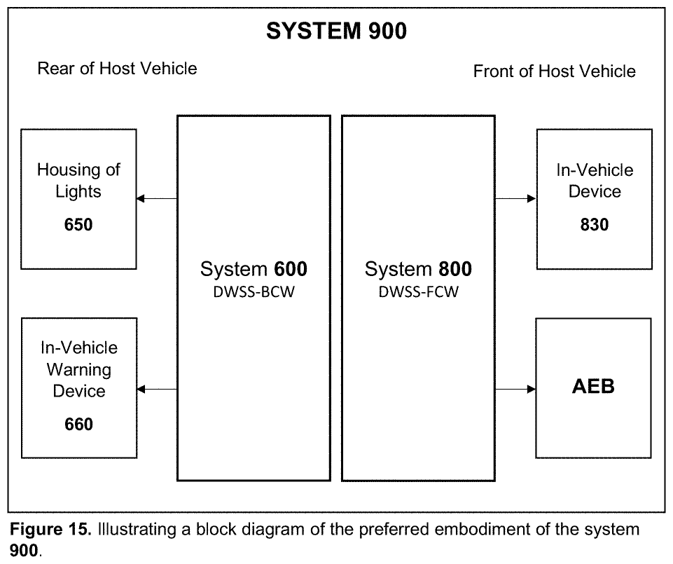

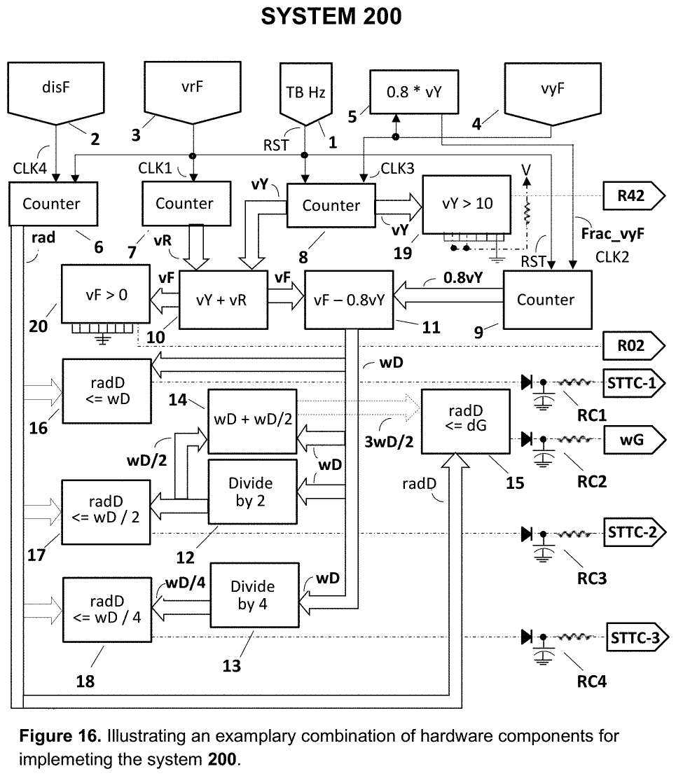

Referring to the FIG. 17 and FIG. 18, the system also includes a ninth section consisting of a logical AND gate 31, pulse amplifier 32 that is comprised of a transistor circuit for activating its paired automotive relay 33 whose functions are of general knowledge. The common pin of the relay 33 is always grounded. When the system simultaneously generates the high pulse R42 (to indicate that the speed vY of the host vehicle Y is greater than 10 km/h) and the high pulse R02 (to indicate that the speed vF of the vehicle FV is greater than 0 km/h), the system feeds the two high pulses R42 and R02 to the logical AND gate 31 whose high output is amplified by the amplifier 32 for providing ground connections G0 through relay 33 for common pin of a second automotive relay 34. When brakes are not applied on the host vehicle Y and the low-speed pulses R02 and R42 are generated in their high state, the relay 34 is not activated and provides the ground connection G0 as ground connection (G1) at its normally closed pin for all lights of the system except for the red light R1 and for the stoplights R2. The system grounds the stoplights R2 independently from the relays so that as soon as the speed of it host vehicle is <=10 km/h, the system can turn on the stoplights R2 regardless of relay operations by the low-speed pulses and by the braking.

The same voltage that feeds brake lights of the host vehicle Y is branched out to activate the relay 34. When brakes are applied on the host vehicle Y, the relay 34 provides the ground connection G0 as ground connection (G2) for the system's red light R1. This way, the system realizes that brakes are applied on the host vehicle Y. If any of the two pulses R02 or R42 is not a high voltage pulse, the output of the gate 31 remains low and the amplifier 32 does not activate the relay 33. As a result, the relay 34 does not receive the ground connection G0 and it does not provide the ground connection G1 or G2 for the system. Consequently, when the speed of the host vehicle Y is less than 10 km/h and the system does not generate the high pulse R42, or when there is no moving vehicle following the host vehicle Y and the system does not generate the high pulse R02, no warning lights of the system get the ground connection G1 or G2 to function except the stoplights R2 which are grounded independently.

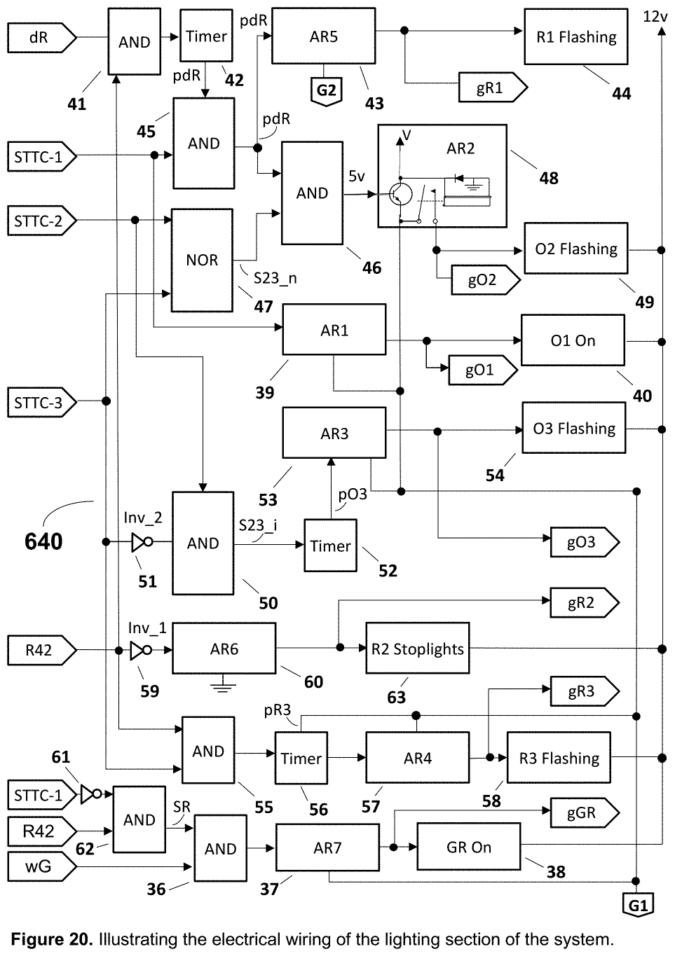

Referring to FIG. 20, the preferred embodiment of the system is also comprised of a tenth section as the lighting section 640 which receives the generated backward STTC and dR pulses, amplifies the pulses for activating a number of automotive relays whose common pins are connected to the ground connections G1 and G2 or directly grounded. The relays provide ground connections which are transferred to the lights GR, O1, O2, 03, R1, R2 and R3 of the system in order to effectuate the signalling of the lights of the system. All lights of the system are housed in the housing 650 and receive their voltage from the battery of the host vehicle.

Referring to FIG. 20, The lighting section is constructed using simple and commonly used electronics and electrical components whose functions are also of general knowledge. Therefore, this disclosure emphasises the configurations of the logical gates of the tenth section. The lighting section in the tenth section is comprised of:

a number of logical AND gates and a NOR gate which receive the generated pulses wG, dR, STTC-1, STTC-2, STTC-3, dR and R42 through a set of dedicated electric wires. The logical gates process the pulses for deciding which lights of the system should be provided with a ground connection to be illuminated;

voltage amplifiers and automotive relays 37, 39, 48, 53 and 57 for providing the ground connection G1 as the ground connection gGR, gO1, gO2, gO3 or gR3 for the lights GR, O1, O2, O3 and R3 when brakes are not applied on the host vehicle;

voltage amplifiers and automotive relay 43 for providing the ground connection G2 as the ground connection gR1 for the red light R1 when brakes are applied on the host vehicle, the pulse dR is generated and the pulse R42 is not generated; and

pulse inverter 59, voltage amplifiers and automotive relay 60 for providing a ground connection as the ground connection gR1 for stoplight 61 (R2) regardless of braking when speed pulse R42 is generated.

Referring to the FIG. 20, when logical AND gate 62 receives the high R42 pulse and the inverted version of low STTC-1 pulse, it produces a high pulse (SR) at its output and feed the SR pulse to one input of a logical AND gate 36. The system feeds the pulse wG to the second input of the gate 36 in order to provide the pulse wG at the output of the gat 36 when both the wG and SR pulses are in high state. This way, the system provides the pulse wG at the output of the gate 36 for turning on the green light when the high R42 pulse (which indicates that the vY is greater than 10 km/h) and the low STTC-1 pulse (which indicates that the FV has not reached the threshold of the calculated wD distance) are generated. The system feeds the provided pulse wG to amplifier relay 37 which provides the ground connection gGR for turning on the green light 38 if brakes are not applied on the host vehicle Y and the ground connection G1 is available to the amplifier and relays 37.

Referring to the FIG. 20, as soon as the system generates the pulse STTC-1, it feeds it to the amplifier relay 39 which provides the ground connection gO1 for turning on the orange light 40 (i.e.: the orange light O1) if brakes are not applied on the host vehicle Y and the ground connection G1 is available to the amplifier and relay 39. So that as long as the STTC-1 pulse is generated and brakes are not applied on the host vehicle, the warning orange light O1 remains on.

Referring to the FIG. 20, In order to for the system to flash the red light R1 every time it generates the pulse dR while brakes are applied on the host vehicle, the system feeds one input of a logical AND gate 41 by the pulse R42 and feeds the second input of the gate 41 by the pulse dR. So that only when the speed of the host vehicle Y is greater than 10 km/h and the pulse R42 is generated, the gate 41 provides the generated dR pulses at its output. The system feeds the output of the gate 41 to a 555 timer 42 that is configured in monostable multivibrator mode to produce a pulse pdR as prolong version of the dR pulses for activating the amplifier relay 43 which provides the ground connection gR1 for flashing the red light 44 (i.e.: the red light R1) if brakes are applied on the host vehicle Y and the ground connection G2 is provided for the amplifier relay 43.

In order for the system to flash the orange light O2 while the STTC_1 is generated and before the STTC-2 or STTC-3 is generated, the system feeds the pdR pulse and the STTC_1 pulse to the inputs of a logical AND gate 45 for providing the pdR pulse at its output only when the STTC-1 pulse is generated. The system feed the pdR pulse that is at the output of the gate 45 to one input of a logical AND date 46. The system also feeds the STTC-2 and the STTC-3 to the two inputs of a logical NOR gate 47 in order to produce a pulse S23_n only when none of the STTC-2 and STTC-3 pulses are generated. The system feed the S23_n to the other input of the gate 46 for providing the pdR pulse at the output of the gate 46 only when the STTTC-1 is generated. The system amplifies the pdR pulse that is provided at the output of the gate 46 by the amplifier 48 in order to activate its associated relay 48 for providing the ground connection G1 and flashing orange light 49 (O2), wherein the flashes of the O2 warn the driver of the FV about the rate of decrease in the headway or distance of the FV from the Y while brakes are not applied on the Y.

Referring to the FIG. 20, in order to flash orange lights O3 at a fixed rate while the STTC-2 pulse is generated and while the STTC-3 pulse is not generated, the system feeds one input of a logical AND gate 50 with the STTC-2 pulse and feeds the second input of the gate 50 with the inverted version of the STTC-3 pulse through an inverter 51. So that when the STTC-2 is generated and the STTC-3 is not generated, the gate 50 produces a high pulse (S23_i) at its output for indicating that the second stage of the unsafe distance wD or the second stage of the TTC is lasting. The system feeds the S23_i pulse to the activation pin of a 555 timer 52 that is configured as an oscillator to produce continuous pulses at the rate of 2 Hz. The system uses the output of the timer 52 for activating amplifier relay 53 which provides the ground connection G1 as (gO3) for flashing orange light 54 (i.e.: the orange light O3) twice per second if brakes are not applied on the host vehicle Y and the ground connection G1 is available to the amplifier and relay 53.

Referring to the FIG. 20, in order to flash the red light R3 at a fixed rate as soon as the STTC-3 pulse is generated and while the speed of the host vehicles Y is greater than 10 km/h and brakes are not applied on the host vehicle, the system feeds the pulse R42 and the STTC-3 pulse to the two inputs of a logical AND gate 55. When both of the pulses R42 and STTC-3 are generated as high pulses, the system uses the high output of the gate 55 to trigger a 555 timer 56 that is configured as an oscillator. The timer 56 produces a sequence of pulses at the rate of 3 Hz for activating amplifier relay 57 which provides the ground connection G1 as (gR3) for flashing red light 57 (i.e.: the red light R3) three times per second if brakes are not applied on the host vehicle Y and the ground connection G1 is available to the system.

145 When speed of the host vehicle is less than a predetermined speed of 10 km/h, the pulse R42 is in low state. Referring to the FIG. 20, in order to turn on the red stoplights R2, the system uses a pulse inverter inv_1 to invert the pulse R42 for activating an amplifier relay 59. The common pin of the relay is always grounded and when the relay is activated by the inverted pulse R42, its normally open pin is closed to provide ground connection (gR2) for the stoplights R2 lights. So that regardless of braking (by the driver and by the AEB), the red light R2 is turned on while speed of the host vehicle Y is less than or equal to the 10 km/h regardless of the distance of its following vehicle.

Referring to the FIG. 19, the DWSS-BCW system 600 may include a multiwire cable for transferring the generated backward warning pulses (wG, STTC-1, STTC-2, STTC-3 and R42) or the ground connections (gGR, gO1, gO2, gO3, gR3, gR1 and gR2) to an adapted receiver inside of the compartment of the host vehicle Y for activating an in-vehicle audio-visual device 660 of the Y which receives its voltage from the battery of the Y. This way, the system alerts the driver of the host vehicle Y that the following-vehicle FV has reached onset of the calculated unsafe backward distance wD from the Y so that the driver of the Y can decide whether to perform preventive maneuvers to prevent the FV from collision with the Y.

The system uses the ground connection gGR that represents the pulse wG for substantially turning on a green light inside the Y in order to inform the driver of the host vehicle Y that a vehicle is following the host vehicle Y in its vicinity. The system uses the ground connection gO1 that represents the STTC-1 pulse for turning on an orange light inside the host vehicle in order to inform the driver of the host vehicle that its following vehicle is now at an unsafe distance from the host vehicle. Each time the system generates the ground connection gO3 for flashing the light O3 on the rear of the host vehicle, the system uses the ground connection gO3 that represents the STTC-2 pulse for flashing an orange light inside the host vehicle Y. This way, the system alerts the driver of the host vehicle that the following-vehicle is travelling at a dangerous dangerously from the host vehicle. Similarly, each time the system generates a flash of the light R3 on the rear of the host vehicle, the system uses the ground connection gR3 that represents the STTC-3 pulse for flashing a red light inside the Y while activating an electric buzzer to create an audio sound inside the Y. This way, the system warns the driver of the host vehicle that its following vehicle is travelling critically close to the host vehicle. Each time the system generates the ground connection gR1 for flashing the red light R1, the system also uses the ground connection gR1 for flashing a red light inside the host vehicle Y in order to inform the driver of the Y that how fast the distance of a following-vehicle FV is reducing from the Y.

### LITERATURE REFERENCES

[1] AUTOMATED EMERGENCY BRAKE SYSTEMS, PUBLISHED PROJECT REPORT PPR 227, European Commission https://trl.co.uk/sites/default/files/PPR227.pdf
[2] ANALYSES OF REAR-END CRASHES AND NEAR-CRASHES IN THE 100-CAR NATURALISTIC DRIVING STUDY TO SUPPORT REAR-SIGNALING COUNTERMEASURE DEVELOPMENT, U.S. Department of Transportation, National Highway Traffic Safety Administration https://www.nhtsa.gov/sites/nhtsa.dotgov/files/analyses20of20rear-end20crashes20and20near-crashes20dot20hs2081020846.pdf
[3] ENHANCED REAR LIGHTING AND SIGNALING SYSTEM, NHTSA https://www.nhtsa.gov/sites/nhtsa.dotgov/files/task20120report.pdf
[4] OPTIMIZATION OF REAR SIGNAL PATTERN FOR REDUCTION OF REAR-END ACCIDENTS DURING EMERGENCY BRAKING MANEUVERS, Dr. rer. nat. Jost Gail Dipl.-Ing. Mechthild Lorig Dr. phil. Christhard Gelau Dipl.-Phys. Dirk Heuzeroth Dr.-Ing. Wolfgang Sievert, Federal Highway Research Institute: https://bastopus.hbz-nrw.de/opus45-bast/frontdoor/deliver/index/docId/288/file/emergency_braking.pdf
[5] TRAFFIC SAFETY AND HUMAN BEHAVIOR, second edition by David Shinar, Ben Gurion university of Negev, 2017
[6] DRIVER BEHAVIOR IN CAR-FOLLOWING: A DRIVING SIMULATOR STUDY, Roma TRE University, Francesco Bella (2010), https://www.humanist-vce.eu/fileadmin/contributeurs/humanist/Berlin2010/Poster_Bella.pdf
[7] USING SHRP2-NDS DATA TO INVESTIGATE FREEWAY OPERATIONS, HUMAN FACTORS, AND SAFETY, FINAL REPORT, Jack D. Jernigan, Ph.D. and Meltem F. Kodaman, University of Michigan, Texas A&M University https://rosap.ntl.bts.gov/view/dot/36653/dot_36653_DS1.pdf?
[8] AN INVESTIGATION OF THE UTILITY AND ACCURACY OF THE TABLE OF SPEED AND STOPPING DISTANCES SPECIFIED IN THE CODE OF VIRGINIA, A Cooperative Organization Sponsored Jointly by the Virginia Department of Transportation and the University of Virginia http://www.vdot.virginia.gov/vtrc/main/online reports/pdf/01-r13.pdf
[9] ANALYSIS OF EMERGENCY BRAKING OF A VEHICLE, Nerijus Kudarauskas (2007), Dept of Automobile Transport, Vilnius Gediminas Technical University, Transport 22:3, 154-159 https://www.tandfonline.com/doi/pdf/10.1080/16484142.2007.9638118
[10] STUDY AND SIMULATION ANALYSIS OF VEHICLE REAR-END COLLISION MODEL CONSIDERING DRIVER TYPES, Journal of Advanced Transportation, Academic Editor: Shamsunnahar Yasmin, 2019, https://www.hindawi.com/journals/jat/2020/7878656/
[11] TRAVELLING SPEED AND THE RISK OF CRASH INVOLVEMENT, VOLUME 1—FINDINGS, 1997 NHMRC Road Accident Research Unit, The University of Adelaide http://casr.adelaide.edu.au/speed/SPEED-V1.PDF
[12] ANALYSIS OF INFLUENCING FACTORS FOR REAR-END COLLISION ON THE FREEWAY, Advances in Mechanical Engineering 2019, Vol. 11(7) 1-10, https://journals.sagepub.com/doi/pdf/10.1177/1687814019865079
[13] A NOTE ON HEAD ACCELERATION DURING LOW-SPEED REAR-END COLLISIONS, Oren Masory, Sylvian Poncet, Mechanical Engineering Department, Florida Atlantic University http://www.eng.fau.edu/directory/faculty/masory/pdf/A-note-on-Head-Acceleration-During-Low-Speed-Rear-End-Collision.pdf

1- A system for dynamically determining backward unsafe distance between a vehicle (Y) that hosts the system and a vehicle (FV) that follows the Y in order to dynamically generate Time-to-Collision pulses on the host vehicle Y in real-time driving, said system comprising:
a) means for measuring speed (vY) of the host vehicle Y and speed (vF) of its following-vehicle FV;
b) means for performing arithmetic operations on the speed of the two vehicles in order to dynamically calculate a distance (wD) between the two vehicles as wD=vF−0.8*vY at the end of equal time intervals;
c) means for measuring relative distance between the two vehicles; and
d) means for comparing the calculated value of the wD with the measured distance in order to generate a Time-to-Collision pulse for determining that the calculated wD is an unsafe distance between the two vehicles whenever the system realizes from the comparison that the measured distance is less than or equal to the calculated distance wD at the end of a time interval, whereby collision warning systems which are comprised of the system can be implemented for dynamically calculating and using the backward unsafe distance wD and the generated Time-to-Collision pulses.

2- A system for dynamically determining backward unsafe distance between a vehicle (Y) that hosts the system and a vehicle (FV) that follows the Y in order to dynamically generate Time-to-Collision pulses on the host vehicle Y in real-time driving, said system comprising:
a) means for measuring speed (vY) of the host vehicle Y and speed (vF) of the following-vehicle FV;
b) means for performing arithmetic operations on the speed of the two vehicles in order to dynamically calculate a distance (wD) between the two vehicles at the end of equal time intervals, wherein the system substantially calculates the distance wD of such magnitude that is greater than the distance (prD) that the following-vehicle FV needs to travel during established average perception-reaction time (prT) of following-vehicles from the time that the host vehicle Y brakes for emergency until the time that the driver of its following-vehicle FV perceives and reacts to the braking by the Y;
c) means for measuring relative distance between the two vehicles; and
d) means for comparing the calculated value of the wD with the measured distance in order to generate a Time-to-Collision pulse for determining that the calculated wD is an unsafe distance between the two vehicles whenever the system realizes from the comparison that the measured distance is less than or equal to the calculated distance wD, whereby collision warning systems which are comprised of the system can be implemented for dynamically calculating and using the backward unsafe distance wD and the generated Time-to-Collision pulses.

3- A system for dynamically calculating forward Time-to-Collision between a vehicle (Y) that hosts the system and a vehicle (LV) that leads the Y in order to dynamically generate forward Time-to-Collision pulses on the host vehicle Y in real-time driving, said system comprising:
a) means for substantially calculating a distance (wD) between the two vehicles so that the wD is greater than the distance (prD) that the FV needs to travel during the established perception-reaction time (prT) of drivers from the time that the lead-vehicle LV brakes for emergency until the time the driver of its following-vehicle Y perceives and reacts to the braking by the LV;
b) means for measuring relative distance between the two vehicles;
c) means for comparing the calculated value of the wD with the measured distance in order to generate the Time-to-Collision pulse for determining that the calculated wD is an unsafe distance between the two vehicles whenever the system realizes from the comparison that the measured distance is less than or equal to the calculated distance wD; and
d) means for transferring the generated TTC pulse to a collision avoidance system of the host vehicle for supporting the collision avoidance system with its functionality.

4- A system for dynamically determining forward unsafe distance between a vehicle (Y) that hosts the system and a vehicle (LV) that leads the Y in order to dynamically produce Time-to-Collision pulses on the host vehicle Y in real-time driving, said system comprising:
a) means for measuring speed (vY) of the host vehicle Y and speed (vL) of the lead-vehicle LV;
b) means for performing arithmetic operations on the speed of the two vehicles in order to dynamically calculate a distance (wD) between the two vehicles Y and LV at the end of equal time intervals, wherein the system substantially calculates the distance wD of such magnitude that is greater than the distance (prD) that the following-vehicle Y needs to travel during established average perception-reaction time (prT) of following-vehicles from the time that the lead-vehicle LV brakes for emergency until the time the host following-vehicle Y perceives and reacts to the braking by the LV; c) means for measuring relative distance between the two vehicles;
d) means for comparing the calculated value of the wD with the measured distance in order to generate a Time-to-Collision pulse for determining that the calculated wD is an unsafe distance between the two vehicles whenever the system realizes from the comparison that the measured distance is less than or equal to the calculated distance wD; and
e) means for transferring the Time-to-Collision pulse to an Autonomous Emergency Braking (AEB) system of the host vehicle for supporting the AEB with braking and steering initiation and intensity.

5- A system for dynamically determining backward unsafe distance between a vehicle (Y) that hosts the system and a vehicle (FV) that follows the Y in order to dynamically generate unsafe distance warning signals on the host vehicle Y in real-time driving, said system comprising:
a) means for generating equal time intervals (TI);
b) means for generating a value (n*vY) that represents the n fraction of speed (vY) of a host vehicle (Y), wherein the n is a fractional or decimal number less than 1;
c) means for generating a value (vF) that represents speed of a vehicle (FV) that follows the Y;
d) means for implementing the logic of a novel algebraic formula that is defined as |wD|=|vF−n*vY| in order to calculate backward distance (wD) between the two vehicles FV and Y at the end of each of the time intervals;
e) means for generating a value that represents measured backward relative distance between the vehicles FV and Y; and
f) means for comparing the calculated value of the distance wD with the measured relative distance in order to generate a Time-to-Collision pulse (STTC-1) while the system is realizing from the comparison that the measured relative distance is less than or equal to the calculated distance wD, wherein the onset of the STTC-1 pulse determines that the calculated wD is an unsafe distance and the FV has reached threshold of the first stage of the calculated backward unsafe distance wD or threshold of the first stage of a calculated Time-to-Collision (STTC), and wherein the magnitude of the calculated STTC is the magnitude of the duration of time that the FV needs to travel the calculated unsafe distance wD, whereby the dynamically generated STTC-1 pulse of the system can be used for generating the backward unsafe distance warning signals on the rear of the vehicle Y so that the FV is encouraged to increase its distance from the Y in order to avoid a possible collision with the Y.

6- The system of claim 5, said system further comprising:
a) means for using the STTC-1 pulse in order to illuminate an orange light (O1) as a backward unsafe distance warning signal on the rear of the Y for alerting the driver of the FV that the FV has reached the threshold of the first stage of the calculated unsafe distance wD or the threshold of the first stage of the calculated Time-to-Collision from the Y; and
b) means for turning off the orange light O1 when the host vehicle Y brakes or when the first stage of the STTC is ended.

7- The system of claim 5, said system further comprising:
a) means for monitoring relative speed (vR) of the two vehicles for producing a backward distance reduction pulse (dR) whenever the system realizes from the monitoring that the vR is increased by a predetermined sample speed (vS) at the end of a time interval, wherein an increase in the relative speed vR denotes a decrease in the relative distance between the two vehicles; and
b) means for using the generated dR pulse in order to flash a red light (R1) for generating backward distance reduction signal on the host vehicle Y if brakes are being applied on the Y and the system is generating said pulse STTC-1, wherein the flashes of the R1 warn the driver of the FV about the rate of decrease in the relative distance of the FV from the Y, so that the quicker the relative distance between the host vehicle Y and its following-vehicle FV is reduced, the faster the red light R1 flashes for indicating the rate of decrease in the relative distance between the FV and the Y.

8- The system of claim 7, said system further comprising means for using the pulse dR within the first stage of the calculated STTC for flashing an orange light (O2) as backward distance reduction signal on the rear of the host vehicle Y while the first stage lasts and brakes are not being applied on the host vehicle Y, whereby the flashes of the O2 warn the driver of the FV about the rate of decrease in the distance of the FV from the Y while brakes are not being applied on the Y.

9- The system of claim 5, said system further comprising:
a) means for providing
$$( \frac{w D}{2} )$$
fraction of the calculated wD, wherein the system uses the
$$( \frac{w D}{2} )$$
for determining a second stage of the STTC;
b) means for comparing said
$$( \frac{w D}{2} )$$
with the relative distance for generating a second pulse (STTC-2) in order to define onset of second stage of the backward unsafe distance wD or second stage of the STTC between the following-vehicle FV and its lead-vehicle Y while the system realizes from the comparison that the measured relative distance is less than or equal to said
$$( \frac{w D}{2} ) ,$$
wherein the onset of the STTC-2 pulse determines end of the first stage of the calculated backward unsafe distance wD or end of the first stage of the STTC; and
c) means for flashing an orange light (O3) at a constant rate on the rear of the Y in order to generate additional backward unsafe distance warning signals while the second stage of the backward unsafe distance wD lasts and brakes are not being applied on the Y,
wherein the flashes of the orange light O3 are meant to warn the dangerously short distance of the FV from the host vehicle Y while the Y is not braking.

10- The system of claim 9, said system further comprising:
a) means for providing
$$( \frac{w D}{4} )$$
fraction of the wD, wherein the system uses the
$$( \frac{w D}{4} )$$
for determining a third stage of the STTC;
b) means for comparing said
$$\frac{w D}{4}$$
with relative distance for generating a pulse STTC-3 in order to define onset of third stage of the backward unsafe distance wD or third stage of the STTC between the host vehicle Y and its following-vehicle FV when the system realizes from the comparison that the measured relative distance is less than or equal to said
$$\frac{w D}{4} ,$$
wherein the onset of the STTC-3 pulse ends the second stage of the calculated backward unsafe distance wD for preventing the flashes of the orange light O3; and
c) means for flashing a red warning light (R3) at a constant rate as backward unsafe distance warning signals on the rear of the host vehicle Y while the system is generating the STTC-3 pulse and brakes are not being applied on the Y, wherein the flashes of the R3 are meant to warn the critically close distance of the FV from the Y.

11- The system of claim 5, said system further comprising means for turning on a red light (R2) as stoplight on the rear of the host vehicle Y when speed of the host vehicle Y is less than or equal to a predetermined speed such as 10 km/h regardless of braking by driver of the Y and regardless of the distance of the FV from the Y.

12- A system or method as defined in claim 5 additionally comprising means for using the STTC-1 pulse for activating a coupled in-vehicle audio-visual device of the host vehicle Y for alerting the driver of the Y that the FV has reached the calculated onset of the backward unsafe distance wD from the Y so that the driver of the Y can decide whether to perform preventive braking and/or steering maneuvers to prevent the FV from collision with the Y.

13- A system for generating dynamically calculated unsafe distance warning signals and distance reduction rate warning signals in real-time driving, said system comprising:
a) means for implementing the logic of a novel algebraic formula that is defined as |wD|=|vF−n*vY| in order to calculate a backward distance (wD) between two following-vehicles in real-time driving during equal time intervals, wherein the vY is speed of a vehicle (Y) which hosts the system, the vF is speed of a vehicle (FV) that follows the Y and the n is a fractional number lass than 1;
b) means for generating a value that represents the speed vY of the host vehicle Y at the end of each of the time intervals;
c) means for generating a value that represents the speed vF of the vehicle FV at the end of each of the time intervals;
d) means for generating a value (vR) that represents measured relative speed of the two vehicles Y and FV at the end of each of the equal time intervals;
e) means for generating a value that represents measured relative distance between the two following-vehicles at the end of each of the time intervals;
f) means for comparing the calculated value of the distance wD with the measured relative distance in order to determine that the wD is an unsafe distance by generating a pulse (STTC-1) while the system is realizing from the comparison that the measured relative distance is less than or equal to the calculated distance wD;
wherein the onset of the STTC-1 pulse denotes that the FV has reached onset of the first stage of the calculated backward unsafe distance wD or the onset of the first stage of Time-to-Collision (STTC) between the two vehicles FV and Y; and wherein the magnitude of the STTC is the magnitude of the duration of the time that the FV needs to travel the calculated unsafe distance wD; and
g) means for monitoring increase in the relative speed vR by a predetermined sample speed (vS) at the end of a time interval, wherein an increase in the relative speed vR denotes a decrease in the relative distance between the two vehicles; and
h) means for generating a distance reduction warning pulse (dR) when the system realizes from the monitoring of the vR that the vR is increased by the predetermined sample speed (vS) at the end of a time interval, wherein the quicker the relative speed vR is increased the faster the dR pulses are generated for indicating faster reduction in the relative distance between the two vehicles.

14- The system of claim 13, said system further comprising:
a) means for using the STTC-1 pulse in order to illuminate an orange warning light (O1) as a backward unsafe distance warning signal on the rear of the Y for alerting the driver of the FV that the FV has reached the threshold of the unsafe distance wD or the TTC from the Y;
b) means for turning off the orange light O1 when the host vehicle Y brakes or when the system does not generate the STTC-1 pulse by realizing from the comparison that the wD is less than the measured relative distance;
c) means for providing
$$( \frac{w D}{2} )$$
fraction of the calculated value wD in order to implement additional stages of the calculated unsafe distance wD or the TTC;
d) means for adding said fraction
$$\frac{w D}{2}$$
to the wD in order to generate a value (dG) for implementing function of a green light (GR);
e) means for comparing the calculated dG with said relative distance in order to produce a pulse (wG) if the system realizes from the comparison that said relative distance is less than or equal to said dG;
f) means for using the pulse wG in order to illuminate a green light GR on the rear of the Y, wherein the GR defines a green zone behind the Y for alerting a possibly inattentive driver of the FV that the FV is following the Y in a proximity of the Y;
g) means for preventing the green light GR from turning on when the system does not generate the wG pulse or when the system generates the STTC-1 pulse or when the system realizes that brakes are being applied on the host vehicle, wherein the change of color of the light from green to the orange or from green to the red brake light reduces the perception time of the driver of the FV towards illumination of the orange or red warning lights;
h) comparator means for comparing the vY with a predetermined speed such as 10 km/h for producing a pulse R42 when the system realizes from the comparison that the vY is less than or equal to the predetermined speed, wherein the system uses the pulse R42 for turning on its red stoplights and de-activating its other lights on the rear side of the host vehicle Y; and
i) comparator means for comparing the vF with zero for producing a high pulse R02 when the system realizes from the comparison that the relative speed is greater than zero, wherein the system uses the pulses R02 and R42 for activating and de-activating all lights of the system except its stoplights.

15- A system for dynamically calculating Time-to-Collision (TTC) between a vehicle (Y) that hosts the system and a vehicle (LV) that leads the Y in real-time driving, said system comprising:
a) means for generating the equal time intervals (TI);
b) means for implementing the logic of a novel algebraic formula that is defined as |wD|=|vY−n*vL| in order to calculate an forward distance (wD) between the vehicle Y and a vehicle (LV) that leads the Y at the end of each of the time intervals, wherein the vY is speed of the Y, the vL is speed of the LV and the n is a fractional or decimal number less than 1;
c) means for generating a value that represents the speed vL of the lead-vehicle LV at the end of each of the time intervals TI;
d) means for generating a value (n*vY) that represents the n fraction of the speed vY of the host vehicle Y at the end of each of the time intervals TI;
e) means for generating a value that represents measured forward relative distance between the vehicles Y and LV at the end of each of the time intervals TI; and
f) means for comparing the calculated value of the distance wD with the measured distance at the end of each of the time intervals in order to generate a pulse (STTC-1) while the system is realizing from the comparison that the measured relative distance is less than or equal to the calculated distance wD, wherein the onset of the STTC-1 pulse determines that the calculated wD is an unsafe distance and the Y has reached threshold of the first stage of the calculated forward unsafe distance wD or threshold of the first stage of a calculated Time-to-Collision (STTC), and wherein the magnitude of the calculated STTC is the magnitude of the duration of time that the Y needs to travel the calculated unsafe distance wD,
whereby the generated STTC-1 pulse of the system can be used for supporting Automatic Emergency Barking (AEB) system of its host vehicle Y with braking and steering initiation and intensity.

16- A system for dynamically calculating Time-to-Collision (TTC) between a vehicle (Y) that hosts the system and a vehicle (LV) that leads the Y in real-time riving, said system comprising:
a) means for generating equal time intervals (TI);
b) means for generating a value that represents speed (vY) of the vehicle Y at the end of each of the time intervals;
c) means for generating a value that represents speed (vL) of the vehicle LV at the end of each of the time intervals;
d) means for generating a value (n*vL) that represents n fraction of the speed vL of the vehicle LV at the end of each of the time intervals;
e) means for implementing the logic of a novel algebraic formula that is defined as |wD|=|vY−n*vL|, wherein the formula uses the speed of the two vehicles for calculating a forward distance (wD) between the two following-vehicles at the end of equal time intervals;
f) means for generating a value that represents measured relative distance between the host vehicle Y and the vehicle LV at the end of each of the time intervals;
g) means for comparing value of the calculated distance wD with the measured distance at the end of each of the time intervals in order to generate a pulse (STTC-1) while the system is realizing from the comparison that the measured relative distance is less than or equal to the calculated distance wD, wherein the onset of the STTC-1 pulse determines that the calculated wD is an unsafe distance and the Y has reached threshold of first stage of the wD or threshold of first stage of a calculated Time-to-Collision (STTC), and wherein the magnitude of the calculated STTC is the magnitude of the duration of time that the Y needs to travel the calculated unsafe distance wD;
h) means for generating a value (vR) that represents measured relative speed of the two vehicles Y and LV at the end of each of the equal time intervals;
i) means for monitoring increase in the relative speed vR by a predetermined sample speed (vS) at the end of a time interval, wherein an increase in the relative speed vR denotes a decrease in the relative distance between the two vehicles;
j) means for generating a distance reduction warning pulse (dR) when the system realizes from the monitoring of the vR that the vR is increased by the predetermined sample speed (vS) at the end of a time interval, wherein the quicker the relative speed vR is increased the faster the dR pulses are generated for indicating faster reduction in the relative distance between the two vehicles;
k) means for providing
$$( \frac{w D}{2} )$$
fraction of the calculated wD, wherein the system uses the
$$( \frac{w D}{2} )$$
for determining a second stage of the STTC;
l) means for comparing said
$$( \frac{w D}{2} )$$
with the relative distance for generating a second pulse (STTC-2) as second forward unsafe distance pulse in order to define second stage of the forward unsafe distance wD or the second stage of the STTC between the host vehicle Y and its lead-vehicle LV while the system is realizing from the comparison that the measured relative distance is less than or equal to said
$$( \frac{w D}{2} ) ,$$
wherein the onset of the STTC-2 ends the first stage of the calculated forward unsafe distance wD or the first stage of the STTC;
m) means for providing
$$( \frac{w D}{4} )$$
fraction of the wD, wherein the system uses the
$$( \frac{w D}{4} )$$
for determining a third stage of the STTC; and
n) means for comparing said
$$\frac{w D}{4}$$
with the relative distance for generating a third pulse (STTC-3) in order to define third stage of the forward unsafe distance wD between the host vehicle Y and its lead-vehicle LV while the system is realizing from the comparison that the measured relative distance is less than or equal to said
$$\frac{w D}{4} ,$$
wherein the onset of the STTC-3 pulse ends the second stage of the calculated forward unsafe distance wD or the second stage of the STTC,
whereby, the system provides its dynamically generated staged Time-to-Collision pulses and its distance reduction rate pulses for supporting functions of a coupled collision warning system of its host vehicle Y.

17- A system for dynamically determining backward unsafe distance between a vehicle (Y) that hosts the system and a vehicle (FV) that follows the Y in order to dynamically generate unsafe distance warning signals on the host vehicle Y in real-time driving, said system comprising:
a) time base generator means 1 for generating a rest pulse (RST) at the end of equal time intervals (TI);
b) sensor means 2 for providing distance pulses of relative distance between a vehicle (Y) that hosts the system and a vehicle (FV) that follows the Y in order to measure the relative distance between the two vehicles by the end of each of the time intervals;
c) sensor means 3 for providing speed pulses of relative speed of the host vehicle Y and the vehicle FV in order to measure the relative speed by the end of each of the time intervals;
d) sensor means 4 for providing speed pulses of speed of the host vehicle Y in order to measure the speed of the Y by the end of each of the time intervals;
e) fractional multiplier means 5 for providing a fraction (n) of the speed pulses of the speed of the Y in order to measure the fraction of the speed of the Y, wherein the n is a predetermined fractional or decimal number less than 1 such as 0.8 for providing 8 pulses per each 10 pulses received from the sensor means 4;
f) voltage regulator means for providing a regulated voltage from the host vehicle's battery for the operation of all components of the system;
g) counter means 6 for counting the distance pulses of the relative distance between the two vehicles in order to generate a binary value that represents the measured relative distance between the Y and the FV at the end of each of the time intervals;
h) counter 7 means for counting the speed pulses of the relative speed of the two vehicles in order to generate a binary value (vR) that represents the measured relative speed of the two vehicles Y and FV at the end of each of the time intervals;
i) counter means 8 for counting the speed pulses of the speed of the Y in order to generate a binary value (vY) that represents the measured speed of the Y at the end of each of the time intervals;
j) counter means 9 for counting the speed pulses of the fraction of speed of the Y in order to generate a binary value 0.8vY as the measured fraction of the speed of the Y at the end of each of the time intervals;
k) a first binary adder means 10 for adding the measured relative speed vR and the measured speed vY for generating a binary value (vF) that represents measured speed of the FV at the end of each of the equal time intervals;
l) subtractor means 11 that is configured for subtracting the binary value 0.8vY from the binary value vF in order to implement a novel algebraic equation (1) defined as (wD) equals to (the vF) minus (the 0.8 multiplied by the vL) denoted as |wD|=|vF−(0.8*vY)|;
m) comparator means 16 for comparing the calculated value of the distance wD with the measured relative distance in order to generate a Time-to-Collision pulse (STTC-1) while the system is realizing from the comparison that the measured relative distance is less than or equal to the calculated distance wD, wherein the onset of the STTC-1 pulse determines that the calculated wD is an unsafe distance and the FV has reached threshold of the first stage of the calculated backward unsafe distance wD or threshold of the first stage of a calculated Time-to-Collision (STTC), and wherein the magnitude of the calculated STTC is the magnitude of the duration of time that the FV needs to travel the calculated unsafe distance wD;
n) binary divider means 12 for providing
$$( \frac{w D}{2} )$$
fraction of the calculated, wherein the system uses the
$$( \frac{w D}{2} )$$
for determining a second stage of the STTC;
o) binary divider means 13 for providing
$$( \frac{w D}{4} )$$
fraction of the calculated wD for defining third stage of the unsafe backward distance wD;
p) comparator means 17 for comparing said
$$\frac{w D}{2}$$
with the relative distance for generating a second unsafe distance warning pulse (STTC-2) while the system is realizing from the comparison that the measured relative distance is less than or equal to said
$$\frac{w D}{2} ,$$
wherein onset of said STTC-2 pulse determines onset of second stage of the unsafe backward distance wD or second stage of the TTC between the host vehicle Y and the FV;
q) comparator means 18 for comparing said
$$\frac{w D}{4}$$
with the relative distance for generating a third unsafe distance warning pulse (STTC-3) while the system is realizing from the comparison that the measured relative distance is less than or equal to said
$$\frac{w D}{4} ,$$
wherein onset of said STTC-3 pulse determines onset of third stage of the unsafe backward distance wD or third stage of the TTC between the host vehicle Y and the FV;
r) memory means 21 for latching the value of vR as reference speed (vRef) at the end of a time intervals;
s) subtractor means 22 for subtracting the value of vR from the vRef in order to produce a value (vRes) at the end of each of the time intervals;
t) comparator means 23 for comparing the vRes with a predetermined sample speed (vS) at the end of each of the time interval in order to generate a pulse (dRst) when the system realizes from the comparison that the vRes is greater than or equal to the vS at the end of a time interval, wherein the dRst pulse indicates that the vR has increased by as much as the vS compared to the vRef which was latched at the end of a previous time interval;
u) logical gate 24 for receiving the dRst and the RST pulse as inputs for generating a forward distance reduction warning pulse (dR) whenever the system generates both the dRst pulse and the RST pulse at the end of a time interval, wherein the quicker the relative speed vR is increased, the faster the relative distance between the two vehicles is reduced and the faster the distance reduction dR pulses are generated;
v) comparator means 25 for comparing the vR with the vRef in order to generate a pulse cRst when the comparator realizes from the comparison that the vRef is less than the vR, wherein the cRef indicates that the vR is reduced compared to the vRef that was latched in the memory at the end of a previous time interval;
w) logical gate 29 for receiving the dR and cRst pulses at one of its inputs and for receiving the RST pulse at its other input in order to generate a pulse UPD at its output whenever the system generates the RST pulse and either the dR or the cRst pulse at the end of a time interval, wherein the system immediately feeds the UPD pulse to the update pin of the memory 21 for resetting the vRef that was latched in the memory to the latest value of the binary number vR that is present at the outputs of the counter 7 at the end of the same time interval when the system generates the UPD pulse;
x) delay circuit 30 for creating a delayed version of the UPD pulse in order to reset the counter 7 to 0 with a few milliseconds of delay after the system resets the vRef, wherein the system restarts counting the speed pulses by the counter 7 during subsequent time intervals after the UPD pulse was generated in order to continue monitoring increases in the vR by as much as the vS;
y) comparator means 19 for comparing the vY with binary representation of a predetermined speed such as 10 km/h for producing a pulse R42 when the system realizes from the comparison that the vY is less than or equal to the predetermined speed, wherein the system uses the pulse R42 for turning on its stoplights and de-activating its other lights;
z) comparator means 20 for comparing the vF with binary representation of zero for producing a pulse R02 when the system realizes from the comparison that the vR is equal to zero, wherein the system uses the pulse R02 for de-activating all lights of the system except its stoplights;
aa) logical gate means 31, voltage amplifier means 32 and automotive relay means 33, wherein the common pin of the relay means 33 is grounded and the normally open pin of the relay 33 provides a ground connection G0 for the common pin of a second automotive relay means 34, wherein the system closes the relay means 33 by generating both of the high pulses R02 and R42 for making the G0 available for the common pin of the relay 34, wherein the normally closed pin of the relay 34 provides a ground connection G1 for a number of amplifier and relays associated with all lights of the system except for the red light 44 (R1) and stoplights 61 (R2) while brakes are not applied on the host vehicle Y and while the pulses R02 and R42 are generated, and wherein the normally open pin of the relay means 34 provides a ground connection G2 for an amplifier and relay 43 that is associated with red light 44 (R1) while brakes are applied on the host vehicle Y and the relay 34 is closed, whereby, the system activates and deactivates its lights when it connects and disconnects the ground connections G1 and G2 based on the pulses R02 and R42;
bb) logical gate means 41 for receiving the R42 and dR pulses at its input for providing the dR pulse at its output when both the dR and the R42 are generated as high state pulses;
cc) timer means 42 for receiving the provided dR pulse from the output pin of the gate means 41 in order to generate a pulse (pdR) as prolonged version of the dR pulse at its output;
dd) logical gate means 45 for receiving the pdR and STTC1 pulses at its inputs in order to provide the pdR pulse at its output while the system is generating both the STTC1 and pdR pulses;
ee) voltage amplifier means 43 which is grounded by the ground connection G2 provided by the relay 34, wherein the amplifier is activated by the pdR pulse for activating its associated relay 4 in order to providing the ground connection G2 as ground connection gR1 for a red light 44 (R1) which receives its voltage for the host vehicle's battery in order to flash the light 44 on the rear of the Y while the system is generating both the STTC-1 and R42 pulses and the brakes are being applied on the Y, and wherein the flashes of the R1 denote rate of decrease in distance of the FV from the Y by braking, so that the quicker the relative distance between the two vehicles is reduced the faster the R1 flashes on the rear of the Y in order to warn the driver of the FV about rate of increase in the relative speed vR or the rate of decrease in the relative distance between the FV and the Y within the calculated warning distance wD;
ff) binary adder means 14 for adding said value
$$\frac{w D}{2}$$
to said value wD in order to generate a binary value (dG;
gg) comparator means 15 for comparing said dG with the relative distance in order to produce a pulse (wG) when the system realizes from the comparison that the measured relative distance is less than or equal to the calculated value of dG;
hh) logical gate means 62 for providing a high pulse (SR) at its output when it receives inverted version of the low STTC-1 pulse (which indicates that the FV has not reached the threshold of the wD) and the high R42 pulse (which indicates that the speed vY of the host vehicle Y is greater than 10 km/h), wherein the system uses the SR pulse for deciding to turn on a green light 38 (GR);
ii) logical gate means 36 for providing the wG at its output when it receives the wG pulse (which indicates that the FV is within the dG distance from the Y) and the SR pulse, wherein the system uses the wG pulse for turning on the green light;
jj) voltage amplifier means 37 which is grounded by the ground connection G2 provided by the relay 34, wherein the amplifier is activated by the provided wG pulse for closing its associated automotive relay 37 in order to provide the ground connection G1 as ground connection gGR for the green light 38 which receives its voltage for the host vehicle's battery, wherein the green light is illuminated if brakes are not applied on the host vehicle Y and the ground connection G1 is available to the amplifier and relays 37, wherein the green light determines a proximity distance of the FV from the Y as a green zone between the two vehicles for as long as the wG pulse is generated, and wherein the green light alerts a possibly inattentive driver of the FV that the FV is following the Y in the proximity of the Y;
kk) voltage amplifier means 39 which is grounded by the ground connection G1 provided by the relay 34, wherein the amplifier is activated by the high STTC-1 pulse for closing its associated relay 39 in order to provide the ground connection G1 as ground connection gO1 for an orange light 40 (O1) which receives its voltage for the host vehicle's battery, whereby the orange light O1 is illuminated on the rear of the Y, wherein the illuminated O1 is meant to be an unsafe distance warning signal on the rear of the Y for as long as the STTC-1 pulse is generated and brakes are not applied on the host vehicle Y, wherein the O1 light alerts driver of the FV that the FV has reached the onset of the calculated unsafe distance wD or the TTC from the Y, and wherein the change of color of the light from green to the warning orange or to the warning red brake lights reduces the perception time of the driver of the FV towards the orange and red lights of the host vehicle Y;
ll) logical gate means 45 for receiving the pdR pulse and the STTC_1 pulse at its inputs in order to provide the pdR pulse at its output only when the STTC-1 pulse is generated;
mm) logical gate 47 for receiving the STTC-2 and the STTC-3 pulses at its inputs in order to produce a pulse S23_n at its output only when none of the STTC-2 and STTC-3 pulses are generated;
nn) logical gate 46 for receiving the pdR pulse from the output of the gate 45 and the S23_n pulse from the output of the gate 47 in order to provide the pdR pulse at the output of the gate 46 when the system generates the high STTC-1 pulse and it does not generate the high STTC-2 and the high STTC-3 pulses, whereby the system flashes an orange light 49 (O2) on the rear of the Y if while the system is generating the STTC-1 pulse, the system generates the dR pulse;
oo) logical gate 50 for receiving the STTC-2 pulse and inverted version of the STTC-3 pulse through an inverter 51 in order to produce a pulse (S23_i) at its output, wherein the S23_i indicates the second stage of the calculated unsafe distance wD or the second stage of the TTC is lasting is lasting;
pp) pulse oscillator means 52 for receiving the S23_i pulse as activation pulse in order to generate pulses (pO3) at constant frequency;
qq) voltage amplifier 53 which is grounded by the ground connection G1 provided by the relay 34, wherein the amplifier is activated by the pO3 pulses for closing its associated automotive relay 53 in order to provide the ground connection G1 as ground connection gO3 for an orange light O3 which receives its voltage for the host vehicle's battery, whereby the O3 flashes at a constant rate on the rear of the Y while the second stage is lasting, and wherein the flashes of the O3 are meant to warn the driver of the FV that the distance of the FV dangerously close to the Y while the Y is not braking;
rr) logical gate means 55 for receiving the pulses R42 and STTC-3 in order to provide the pulse STTC-3 available at its output only when the R42 pulse is generated in its high state for indication that the speed of the host vehicle is greater than a predetermined speed such as 10 km/h;
ss) pulse oscillator means 56 for receiving the provided STTC-3 pulse as activation pulse in order to generate pulses (pR3) at constant frequency while the third stage of the calculated unsafe distance wD or the third stage of the TTC lasts;
tt) voltage amplifier and relay 57 which is grounded by the ground connection G1 provided by the relay 34, wherein the amplifier is activated by the pR3 pulses for activating its associated relay 57 in order to provide the ground connection G1 as ground connection gR3 for a red warning light 58 (R3) which receives its voltage for the host vehicle's battery, whereby the light 58 flashes at a constant rate on the rear of the Y while the system is generating the STTC-3 pulse and while brakes are not applied on the host vehicle Y, and wherein the flashes of the light 58 are meant to alert the driver of the vehicle FV that the FV is critically close to its lead-vehicle Y;
uu) inverter means 59 for inverting the pulse R42, wherein the system uses the pulse R42 for turning on a stoplight 63 (R2) when the speed vY of the host vehicle is less than or equal to the predetermined speed of 10 km/h and the R42 pulse is in its low speed; and
vv) voltage amplifier means 60 which is grounded by the ground connection G1 provided by the relay 34, wherein the amplifier is activated by inverted version of the R42 pulse in order to activate its associated relay 60 when the pulse R42 is in its low state, and wherein the relay 60 provides the ground connection G1 as ground connection gR2 for stoplight 63 which receives its voltage for the host vehicle's battery, whereby the stoplights 63 are illuminated on the rear of the host vehicle Y when the system generates the low R42 for indication that the speed of the Y is less than the predetermined speed of 10 km/h.

18- A system or method as defined in claim 17 further comprising means for transferring the backward warning pulses wG, STTC-1, STTC-2, STTC-3 and dR to the inside of the host-vehicle Y in order to activate an adapted in-vehicle audio-visual device of the host vehicle Y for alerting the driver of the Y about unsafe distance and distance reduction rate of its following-vehicle FV so that the driver of the Y can decide whether to perform preventive braking and steering maneuvers for preventing the FV from colliding with the Y.

19- A system for generating dynamically calculated forward unsafe distance warning pulses and forward distance reduction rate pulses, said system comprising:
a) time base generator means 1 for generating a rest pulse (RST) at the end of equal time intervals (TI);
b) sensor means 2 for providing distance pulses of relative distance between a vehicle (Y) that hosts the system and a vehicle (LV) that leads the Y in order to measure the relative distance between the two vehicles by the end of each of the time intervals;
c) sensor means 3 for providing speed pulses of relative speed of the host vehicle Y and the LV in order to measure the relative speed by the end of each of the time intervals;
d) sensor means 4 for providing speed pulses of speed of the LV in order to measure the speed of the LV by the end of each of the time intervals;
e) fractional multiplier means 5 for providing a fraction (n) of the speed pulses of the speed of the LV in order to measure the fraction of the speed of the LV, wherein the n is a predetermined fractional or decimal number less than 1 such as 0.8 for providing 8 pulses per each 10 pulses received from the sensor means 4;
f) voltage regulator means for providing a regulated voltage from the host vehicle's battery for the operation of all components of the system;
g) counter means 6 for counting the distance pulses of the relative distance between the two vehicles in order to generate a binary value that represents the measured relative distance between the Y and the LV at the end of each of the time intervals;
h) counter 7 means for counting the speed pulses of the relative speed of the two vehicles in order to generate a binary value (vR) that represents the measured relative speed of the two vehicles Y and LV at the end of each of the time intervals;
i) counter means 8 for counting the speed pulses of the speed of the LV in order to generate a binary value (vL) that represents the measured speed of the LV at the end of each of the time intervals;
j) counter means 9 for counting the speed pulses of the fraction of speed of the LV in order to generate a binary value 0.8vL the measured fraction of the speed of LV at the end of each of the time intervals;
k) a first binary adder means 10 for adding the measured relative speed vR and the measured speed vL for generating a binary value (vY) that represents measured speed of the Y at the end of each of the equal time intervals;
l) subtractor means 11 that is configured for subtracting the binary value 0.8vL from the binary value vY in order to implement a novel algebraic equation (1) defined as (wD) equals to (the vY) minus (the 0.8 multiplied by the vL) denoted as |wD|=|vY−(0.8*vL)|, wherein the resultant value of the wD is a binary number that represents first stage of a calculated unsafe forward distance between the host vehicle Y and the LV, and wherein the system uses the calculated value of wD for generating unsafe forward distance warning signal;
m) binary divider means 12 that is configured for providing
$$( \frac{w D}{2} )$$
fraction of the calculated distance wD, wherein the system uses the
$$( \frac{w D}{2} )$$
for defining second stage of the wD in order to generate additional unsafe forward distance warning signal;
n) binary divider means 13 that is configured for providing
$$( \frac{w D}{4} )$$
fraction of the calculated distance wD, wherein the system uses the
$$\frac{W D}{4}$$
for defining third stage of the wD in order to generate additional unsafe forward distance warning signal;
o) comparator means 16 for comparing the calculated value of the distance wD with the measured relative distance in order to generate a Time-to-Collision pulse (STTC-1) while the system is realizing from the comparison that the measured relative distance is less than or equal to the calculated distance wD,
wherein the onset of the STTC-1 pulse determines that the calculated wD is an unsafe distance and the host vehicle Y has reached threshold of the first stage of the calculated backward unsafe distance wD or threshold of the first stage of a calculated Time-to-Collision (STTC), and wherein the magnitude of the calculated STTC is the magnitude of the duration of time that the Y needs to travel the calculated unsafe distance wD;
p) comparator means 17 for comparing said
$$\frac{w D}{2}$$
with the relative distance for generating a second unsafe distance warning pulse (STTC-2) if the system realizes from the comparison that the measured relative distance is less than or equal to said
$$\frac{w D}{2}$$
at the end of the time interval TI, wherein onset of said STTC-2 pulse determines onset of second stage of the unsafe forward distance wD or second stage of the STTC between the host vehicle Y and the LV;
q) comparator means 18 for comparing said
$$\frac{w D}{4}$$
with the relative distance for generating a pulse (STTC-3) if the system realizes from the comparison that the measured relative distance is less than or equal to said
$$\frac{w D}{4}$$
at the end of the time interval TI, wherein onset of said STTC-3 determines onset of third stage of the unsafe forward distance wD or third stage of the STTC between the host vehicle Y and the LV;
r) memory means 21 for latching the value of vR as reference speed (vRef) at the end of a time intervals;
s) subtractor means 22 for subtracting the vR from the vRef in order to produce a value (vRes) at the end of each of the time intervals;
t) comparator means 23 for comparing the vRes with a predetermined sample speed (vS) at the end of each of the time interval in order to generate a high pulse (dRst) when the system realizes from the comparison that the vRes is greater than or equal to the vS at the end of a time interval, wherein the high dRst pulse indicates that the vR has increased by as much as the vS compared to the vRef latched as the end of a previous time interval;
u) logical gate 24 for receiving the dRst and the RST pulse as inputs for generating a forward distance reduction warning pulse (dR) whenever the system generates both the dRst pulse and the RST pulse at the end of a time interval, wherein the quicker the relative speed vR is increased, the faster the relative distance between the two vehicles is reduced and the faster the distance reduction dR pulses are generated;
v) comparator means 25 for comparing the vR with the vRef in order to generate a high pulse cRst when the comparator realizes from the comparison that the vRef is less than the vR, wherein the cRef indicates that the vR is reduced compared to the vRef that was latched in the memory at the end of a previous time interval;
w) logical gate 29 for receiving the dR and cRst pulses at one of its inputs and for receiving the RST pulse at its other input in order to generate a pulse UPD at its output whenever the system generates the RST pulse and either the dR or the cRst pulse at the end of a time interval, wherein the system immediately feeds the UPD pulse to the update pin of the memory 21 for resetting the vRef that was latched in the memory to the latest value of the binary number vR that is present at the outputs of the counter 7 at the end of the same time interval when the system generates the UPD pulse; and
x) delay circuit 30 for creating a delayed version of the UPD pulse in order to reset the counter 7 to 0 with a few milliseconds of delay after the system resets the vRef, wherein the system restarts counting the speed pulses by the counter 7 during subsequent time intervals after the UPD pulse was generated in order to continue monitoring increases in the vR by as much as the vS,
whereby, the system provides its dynamically generated staged Time-to-Collision warning pulses and its distance reduction rate warning pulses for an Automatic Emergency Barking (AEB) system of its host vehicle for supporting the AEB with braking and steering initiation and intensity.

20- A system as defined in claim 19, said system further comprising means for transferring the forward warning pulses STTC-1, STTC-2, STTC-3 and dR inside the host vehicle Y in order to activate an adapted in-vehicle audio-visual device of the host vehicle Y for alerting the driver of the host vehicle Y that the Y has reached onset of the calculated forward unsafe distance wD from the LV so that the driver of the Y can decide whether to perform preventive maneuvers to prevent the Y from colliding with the LV.

21- A method for generating dynamically calculated unsafe distance warning pulses and distance reduction rate warning pulses in real-time driving, said method comprising:
a) Arithmetic calculator means used to calculate the logic of a novel algebraic formula that is defined as |wD|=|vF−n*vY| in order to calculate backward distance (wD) between two following-vehicles in real-time driving at the end of equal time intervals, wherein the vY is speed of a vehicle (Y) which hosts the signals, the vF is speed of a vehicle (FV) that follows the Y and the n is a fractional number lass than 1;
b) speed measurement means used to generate the value vY at the end of each of the time intervals;
c) speed measurement means used to generate the value vF at the end of each of the time intervals;
d) speed measurement means used to generate a value that represents measured relative speed of the two vehicles at the end of each of the equal time intervals;
e) distance measurement means used to generate a value that represents measured relative distance between the two following-vehicles at the end of each of the time intervals;
f) magnitude comparator means used to compare the magnitude of the calculated value of the distance wD with the magnitude of the measured relative distance in order to determine that the wD is an unsafe distance by generating a Time-to-Collison pulse while the comparator is realizing from the comparison that the measured relative distance is less than or equal to the calculated distance wD, wherein the magnitude of the Time-to-Collision pulse is the magnitude of the duration of time that the FV needs to travel the calculated unsafe distance wD, and wherein the onset of the Time-to-Collision pulse denotes that the FV has reached onset of the first stage of the calculated backward unsafe distance wD between the two vehicles FV and Y;
g) speed monitoring means used to monitor increase in the relative speed by a predetermined sample speed at the end of a time interval, wherein an increase in the relative speed denotes a decrease in the relative distance between the two vehicles; and
h) pulse generator means used to generate a distance reduction warning pulse when the speed monitoring means realizes from the monitoring that the relative speed has increased by the predetermined sample speed at the end of a time interval, wherein the quicker the relative speed is increased the faster the distance reduction warning pulses are generated for indicating faster reduction in the relative distance between the two vehicles,
whereby, collision warning systems that are comprised of the method can be implemented for generating and using the Time-to-Collison pulse.

22- A method for generating dynamically calculated unsafe distance warning pulses and distance reduction rate warning pulses in real-time driving, said method comprising:
a) Arithmetic calculator means used to calculate the logic of a novel algebraic formula that is defined as |wD|=|vY−n*vL| in order to calculate forward distance (wD) between two following-vehicles in real-time driving at the end of equal time intervals, wherein the vY is speed of a vehicle (Y) which hosts the pulses, the vL is speed of a vehicle (LV) that leads the Y and the n is a fractional number lass than 1;
b) speed measurement means used to generate the value vY at the end of each of the time intervals;
c) speed measurement means used to generate the value vL at the end of each of the time intervals;
d) speed measurement means used to generate a value that represents measured relative speed of the two vehicles at the end of each of the equal time intervals;
e) distance measurement means used to generate a value that represents measured relative distance between the two following-vehicles at the end of each of the time intervals;
f) magnitude comparator means used to compare the magnitude of the calculated value of the distance wD with the magnitude of the measured relative distance in order to determine that the wD is an unsafe distance by generating a Time-to-Collison pulse while the comparator is realizing from the comparison that the magnitude of the measured relative distance is less than or equal to the magnitude of the calculated distance wD, wherein the magnitude of the Time-to-Collision pulse is the magnitude of the duration of time that the Y needs to travel the calculated unsafe distance wD, and wherein the onset of the Time-to-Collision pulse denotes that the Y has reached onset of the first stage of the calculated backward unsafe distance wD between the two vehicles;
g) speed monitoring means used to monitor increase in the relative speed by a predetermined sample speed at the end of a time interval, wherein an increase in the relative speed denotes a decrease in the relative distance between the two vehicles; and
h) pulse generator means used to generate a distance reduction warning pulse when the speed monitoring means realizes from the monitoring that the relative speed has increased by the predetermined sample speed at the end of a time interval, wherein the quicker the relative speed is increased the faster the distance reduction warning pulses are generated for indicating faster reduction in the relative distance between the two vehicles, whereby, collision warning systems that are comprised of the method can be implemented for generating and using the Time-to-Collison pulse.
